(19) United States
(12) Patent Application Publication
(10) Pub. No.: US 2019/0082724 A1
(43) Pub. Date: Mar. 21, 2019

(54) PEA FIBER PRODUCT

(71) Applicants: Dakota Rose Novak, Forest Lake, MN (US); Marguerite Yang, Edina, MN (US); Kushal Narayan Chandak, Minneapolis, MN (US)

(72) Inventors: Dakota Rose Novak, Forest Lake, MN (US); Marguerite Yang, Edina, MN (US); Kushal Narayan Chandak, Minneapolis, MN (US)

(21) Appl. No.: 16/137,945

(22) Filed: Sep. 21, 2018

Related U.S. Application Data
(60) Provisional application No. 62/561,666, filed on Sep. 21, 2017.

(51) Int. Cl. A23L 11/00; A23L 2/52; A23L 23/00; A21D 2/36; A23J 3/22; A21D 13/80; A21D 13/066; A23G 3/48; A23L 33/22

(52) U.S. Cl. CPC A23L 11/05; A23L 2/52; A23L 23/00; A21D 2/362; A23V 2002/00; A21D 13/80; A21D 13/066; A23G 3/48; A23L 33/22; A23J 3/227

(57) ABSTRACT

The present invention relates to a pea fiber product that is at least 45 dwt. % pea fiber, preferably at least 70 dwt. %, most preferably 90 dwt. % fiber of which at least 5 dwt. % fiber is soluble, preferably 10 dwt. % is soluble, most preferably 20 dwt. % is soluble, as well as the process of making such, and the beverages, sauces, bakery, and aerated products that use such. The resultant pea fiber product is such that it has a same day viscosity of 300-1100 cp at 15 wt. % concentration and of 2150-2950 cp at 17 wt. % according to viscosity Test A run at 30 RPM; and has a 60 hour viscosity of 1420-2220 cp at 15 wt. % concentration and of 6400-7200 cp at 17 wt. % concentration according to viscosity Test A.

### CROSS-REFERENCE TO RELATED APPLICATIONS

The present application claims the benefit of U.S. Provisional Application No. 62/561,666, filed Sep. 21, 2017, entitled “Pea Fiber Product”, which is hereby incorporated by reference in its entirety.

### BACKGROUND OF THE INVENTION

The present invention is broadly concerned with a pea fiber product that can be used to make nutritious, palatable, high fiber content food products that can be labeled as containing high levels of dietary fiber. In particular, but not exclusively, the present invention is concerned with a pea fiber product that can be used in high quantities in food products with both low and high water content, including but not limited to bakery, sauce, and beverage products.

This present invention includes a method for making this pea fiber product that involves separating pea internal fiber from a pea center through milling (wet or dry). Preferably, the present invention includes a method for making this pea fiber product that involves separating a pea hull from a pea center through milling, and optionally cleaning the pea hull fiber material. The pea fiber material (internal or hull) is then ground to a fine powder, and finally the pea fiber material is heat treated to create the pea fiber product of this invention. This fiber heat treating process can further include a wetting step before, after, or concurrent to the removal of the pea fiber material from the pea seed.

This heat treatment process can further include a purifying process wherein the content of protein and starch in the ground fiber material (sourced from hull or interior) is reduced before heat treating the pea fiber material using a heating apparatus with shear and mixing. Preferably, this pea fiber material can be washed such that some of the protein and/or starch content is reduced without chemical changes to the remaining ground pea fiber material resulting in at least 45 dwt. % fiber, preferably 70 dwt. % fiber, most preferably 90 dwt. % fiber as measured by AOAC method 991.43. The final material (with or without optional further washing) is a pea fiber product of at least 45 dwt. % fiber, preferably 70 dwt. % fiber, most preferably 90 dwt. % fiber as measured by AOAC method 991.43. Preferably, the heating process that converts the ground pea fiber intermediate material to the final pea fiber product of this invention includes mixing the ground pea fiber intermediate material with water (no more than 40 wt. %) and then heating the wetted pea fiber material under conditions of shear and pressure in an apparatus such that the ground pea fiber intermediate product is made first into expanded pieces, that can also be ground into powder. This heating process is such that it gives unique properties to the heated pea fiber product of this invention, both as expanded pieces and as ground powder.

The resultant pea fiber product of this invention can then be used to make low and high water content food products with the texture and flavor desired by consumers, as well as providing viscosity, water absorption, bulk, as well as providing suspension and water absorption stability.

Fiber has been defined to be the components of plants that resist human digestive enzymes, a definition that includes lignin and polysaccharides. These digestible enzyme cannot split the glycosidic bonds and the fiber moves through the digestive system to the large intestine. Chemically, fiber consists of non-starch polysaccharides such as cellulose, pectin, lignin and oligosaccharides.

Such fiber can be measured according to AOAC method 991.43. An added benefit of the use of the pea fiber product of this invention is the ability to claim the fiber as “dietary fiber” under 21 CFR sect. 101.9 (c)(6)(i) as the fiber content of the pea fiber product of this invention is derived from the hull (or interior) of the pea without chemical synthesis or chemical separation. Another added benefit of the use of the pea fiber product of this invention is the “Ready-To-Eat” nature of the product due to the heat treatment eliminating microbiological content of the natural fiber material, including the fiber that is from the hull milled from the pea center. Another added benefit of the use of the pea fiber product of this invention is its slightly toasted, nutty flavor, as well as the absence of a “pea” or “beany” flavor often present in byproducts of pea manufactured materials.

Another benefit of the pea fiber product of this invention is that it could be labeled natural, certified organic, and non-GMO. All of which are benefits to consumers actively choosing ingredients for their diets that they believe are healthy alternatives.

The role of pea fiber in finished consumer food products varies with each type of product. Pea fiber can have several functions in finished food products, including but not limited to bulking, creating body and viscosity, suspending solids, and absorbing and controlling water through manufacturing. Pea fiber can also be added to food product formulas to maintain water dispersion and absorption through temperature cycling.

Pea fiber can also be used to reduce finished product caloric content by its bulk being used to reduce fat, starch, and sugar content in finished food products. Pea fiber has the added advantage of having less digestibility than protein, fat, starch, and sugar.

Other polysaccharide ingredients are touted also as fiber and also as substitutes for fat, starch, and sugar. For example, polydextrose is also a polysaccharide material with low digestibility, hence labeled by some as “fiber”. Polydextrose was developed as a bulking agent and a fat, starch, and sugar replacer. Unlike pea fiber, polydextrose is a synthesized ingredient, thus neither certifiable as organic or non-GMO. Other such polysaccharide ingredients include fructooligosaccharides (synthesized fructose based polysaccharides).

Bakery products cover a wide range of finished consumer food products, including but not limited to those based on polysaccharides for structure and flavor, usually wheat based. Low gluten bakery products cover such food products wherein the wheat flours are replaced with plant (e.g., rice, soybean, oat, corn) flours. Such low gluten bakery products can also include pea flour. The loss of finished bakery product elasticity and body and chewiness from the lack of gluten protein from wheat is sometimes substituted with protein from milk, egg, soybeans, or lentils (such as peas and beans).

Bakery products include, but are not limited to, cookies, cakes, pancakes, waffles, tortillas, biscuits, pretzels, ice cream cones, crackers, muffins, scones, and other starch/flour based finished consumer food products.

Beverages cover a wide range of finished consumer food products, including but not limited to milks (e.g., dairy and non-dairy), sports/nutritional drinks, aseptic packed drinks, acidified hot-fill packed drinks, and fruit juice or fruit flavored drinks. Beverages can be carbonated or non-carbonated. Beverages can be produced such that they are to be stored at ambient, refrigerated, or frozen temperatures. Manufactures usually label their products with directions to store the beverages at refrigerated temperatures once the package has been opened. Some beverages are sold in liquid form and others are sold as dry mixes, which consumers hydrate before consuming.

Sauces cover a wide range of finished consumer food products (and intermediates to finished food products), including by not limited to gravies, white sauces, fruit based sauces (e.g., sweet and sour sauces), fermented product bases (e.g., soy sauces, teriyaki sauces, oyster sauces), and tomato based sauces (e.g., barbeque sauces, spaghetti sauces). Sauces could be processed by retort, aseptic, acidified food, or kettle cook. Some sauces are sold in liquid form and others are dry mixes, which consumers or cooks hydrate before consuming or using. Some sauces are sold as a part of entrees (e.g., gravy on meat patties), which are stored frozen and then heated by consumers. Sauce products are usually labeled to be stored at refrigerated temperatures once opened. An ideal beverage and sauce would maintain its texture during ambient and refrigerated storage as well as be stable to freeze/thaw temperature cycles. An ideal dry mix beverage would maintain its suspension the day of preparation and ideally, through the next day. Though often prepared as consumers, remaining prepared beverage could be stored and consumed over 24 hours.

Consumer trends have shown a growing interest and belief in the need for increased fiber in their diets, especially fiber that tastes good and has desirable texture.

High fiber content bakery food products, such as cookies, crackers and snacks, as well as high fiber high water content food products, such as beverages and sauces, offer potential health and weight benefits such as satiety, weight management, blunted glucose response (GR) and/or reduced glycemic index (GI) which would make them a better choice for individuals who try to manage their weight and for diabetics. Glycemic index (GI) refers to how rapidly a food causes blood sugar to rise. High-GI foods, like white bread and potatoes, tend to spur a quick elevation in blood sugar, while low-GI foods, such as lentils (including peas), soybeans, yogurt and many high-fiber grains, create a more gradual increase in blood sugar. The blood-sugar surges associated with high-GI diets may eventually damage the macula, because excess blood sugar interacts with other molecules, like fats and proteins, to form what are called glycated molecules. This process, in turn, can put the body under more oxidative stress, which over time damages cells and may lead to various diseases.

Dietary fibers can act by changing the nature of the contents of the gastrointestinal tract and by changing how other nutrients and chemicals are absorbed. Some types of soluble fiber absorb water to become a viscous substance that is fermented by bacteria in the digestive tract. Some types of insoluble fiber have bulking action and are not fermented. Lignin, a major dietary fiber source, may alter the rate of metabolism of soluble fibers. Other types of insoluble fiber are fully fermented. Some but not all soluble plant fibers block intestinal mucosal adherence and translocation of potentially pathogenic bacteria and may therefore modulate intestinal inflammation, an effect that has been termed caotrabiotic.

Advantages of consuming fiber are the production of healthful compounds during the fermentation of soluble fiber, and insoluble fiber's ability (via its hygroscopic properties) to increase bulk, soften stool, and shorten transit time through the intestinal tract. Fiber supplements have been used by consumers for managing irritable bowel syndrome. A disadvantage of a diet high in fiber is the potential for significant intestinal gas production and bloating.

Though all plants contain some fiber, the means by which that fiber is separated from the plant and further processed effects the functionality of the resulting fiber material. Peas contain fiber both in their hull (outer portion) and in their seed (inner portion). The pea fiber product of this invention would be defined as dietary fiber under FDA (21 CFR sect. 101.9 (c) (6) (i) as it is “intact and intrinsic”, that is, in its natural state. This pea fiber product (especially the hull sourced pea fiber) would be similar to the “bran” example used by the FDA as an example of plant fiber that is “intact and intrinsic”.

Consumers on vegan diets are interested in avoiding finished food products that contain animal based proteins, which include proteins from egg, meat, and milk sources. The avoidance of gelatin containing products can also be attributed by religious dietary laws. As proteins provide the means for absorbing and maintaining water content with traditional food products, the lack of the use of these traditional proteins can create product defects (e.g., lack of solubility and suspension, lack or body and volume).

Unlike soybeans, peas (and other lentils) are not allergens, do not cause digestive problems, and have little if any flavor. Pea proteins have been used in many consumer products as protein alternatives for gluten, animal, milk, and soybean based proteins. A natural ingredient to partner with pea protein is pea fiber. Pea fiber also has the ability to work with non-gluten products by giving the water absorption and water maintenance that gluten performs in wheat based bakery, sauce, and beverage products.

Pea fiber material can be used in a large range of food products to add thickness and to control moisture (e.g., by water absorption and water solubility). But the amount of many fiber materials that can be added to a food formulation is limited due to the high water absorption of many fiber products. High levels of addition of most fibers leads to too much viscosity, as well as a gritty or pulpy texture. Manufacturers would prefer to be able to add more fiber to their products, while maintaining the consumer expected finished product viscosity and mouthfeel. Though all fiber materials absorb water, as water is the cheapest of ingredients, manufacturers would prefer to add a fiber that can add volume while increasing (and maintaining) water content during production and storage.

There is a growing consumer trend to eat healthier, including eating food products that are high in dietary fiber. But consumers also want to indulge themselves with food products that are good tasting and have very appealing, familiar texture and appearance. Texture and appearance stability is very important for the current consumers who want prepared products or who want products they can prepare ahead of time and store for convenient later use.

The problem is in creating a fiber product and fiber added food products with appropriate product viscosity and suspension without creating objectionable mouthfeel and appearance, which becomes worse with refrigeration and frozen storage.

Therefore there is a need for an alternative fiber product that has an acceptable flavor and delivers an acceptable texture and appearance, as well as suspension and water absorption stability in storage. This alternative fiber product must have the functional characteristics necessary to meet the needs of manufacturers and consumers.

Therefore there is a need for a pea fiber product with adjusted physical characteristics that would allow the pea fiber product to have the water absorption and water solubility properties necessary to allow a high level of fiber addition to create a consumer expected thickness and creamy mouthfeel texture in both low and high water content food products, even under refrigeration and freeze/thaw cycle storage conditions.

### SUMMARY OF INVENTION

The present invention relates to a pea fiber product that is at least 45 dwt. % pea fiber, preferably at least 70 dwt. %, most preferably 90 dwt. % fiber of which at least 5 dwt. % fiber is soluble, preferably 10 dwt. % is soluble, most preferably 20 dwt. % is soluble, as well as the process of making such, and the beverages, sauces, bakery, and aerated products that use such. The resultant pea fiber product is such that it has a same day viscosity of 300-1100 cp at 15 wt. % concentration and of 2150-2950 cp at 17 wt. % according to viscosity Test A run at 30 RPM; and has a 60 hour viscosity of 1420-2220 cp at 15 wt. % concentration and of 6400-7200 cp at 17 wt. % concentration according to viscosity Test A. Preferably, the pea fiber product meets USDA organic certification requirements. Preferably, the pea fiber product meets FDA non-GMO requirements.

### DETAILED DESCRIPTION OF INVENTION

The present invention relates to a pea fiber product that is at least 45 dwt. % pea fiber, preferably at least 70 dwt. %, most preferably 90 dwt. % fiber of which at least 5 dwt. % fiber is soluble, preferably 10 dwt. % is soluble, most preferably 20 dwt. % is soluble, as well as the process of making such, and the beverages, sauces, bakery, and aerated products that use such. The resultant pea fiber product is such that it has a same day viscosity of 300-1100 cp at 15 wt. % concentration and of 2150-2950 cp at 17 wt. % according to viscosity Test A run at 30 RPM; and has a 60 hour viscosity of 1420-2220 cp at 15 wt. % concentration and of 6400-7200 cp at 17 wt. % concentration according to viscosity Test A. Preferably, the pea fiber product meets USDA organic certification requirements. Preferably, the pea fiber product meets FDA non-GMO requirements.

The process of this invention is a method of manufacturing the pea protein product of this invention with physical characteristics that give it unique functional characteristics that make it useful in creating both high and low moisture food products with the texture, appearance, viscosity, and mouthfeel characteristics desired by consumers. This process is not limited by the number of process steps, or the order in which the process steps are performed.

The product of this invention contains pea fiber product. The fiber can be sourced from anywhere in the pea seed (including hull and interior of pea). Preferably, the pea fiber is sourced from the pea hull. As used herein, “pea” means the mostly small spherical seed of the pod fruit Pisum sativum. In particular, the pea used in this invention is from varieties of the species typically called field peas or yellow peas that are grown to produce dry peas that are shelled from the mature pod. Peas have been harvested as human food as far back as the early third century BC. Peas are traditional foods in the diets of people living on every continent, most particularly in European, Asian, North Africa, and North American countries. Though traditionally a cool-season crop, new varieties have been breed that can be grown in hotter climates and also in dryer climates. Peas also have been breed to contain a range of physiological characteristics. These breeding practices, as well as the cultural eating histories of so many people, make peas an excellent source for protein and fiber for many consumers world-wide.

All percentages are in dry weight (“dwt”) unless specified otherwise as total weight (“wt”).

Peas as traditionally harvested and dried, have a hull portion (about 6-10% dwt. of whole pea) and a seed portion (about 90-94% dwt. of whole pea). When the hull is removed, the content of the resulting hull material includes mostly fiber, but also some protein and starch. The hull portion of the pea may be removed from the whole pea by a number of processes, which can be done by various methods known in the art. These methods include, but are not limited to dry and wet milling. The pea fiber product of this invention is not limited by the specific variety of peas used in the manufacture of the product of this invention. The pea fiber product of this invention is also not limited by the specific amount of fiber in the variety of peas used in the manufacture of the pea fiber product of this invention.

Preferably, the pea varieties used to produce the pea fiber product of this invention are non-GMO by FDA regulations and as such are naturally breed and not genetically created. Preferably, the pea varieties used to produce the pea fiber product of this invention are Organic Certified by USDA regulations.

Non-GMO means not genetically modified. FDA.gov website currently includes guidance for manufactures who wish to voluntarily label food as containing or not-containing genetically engineered ingredients. Additional labeling regulations as to mandatory labeling of foods containing genetically engineered ingredients are being developed for enforcement starting roughly 2020. Under these regulations, traditional breeding of pea plants would be free of genetically engineering.

Organic Certified means that the source of the ingredients and the finished food product have been produced according to specific requirements pea plants would only come in contact with organically approved herbicides, pesticides, process aids and cleaning materials.

Creamy mouthfeel means that the product has a smooth and non-gritty feel in the mouth, while also having some thickness that coats the tongue and mouth surfaces. Gritty mouthfeel means that the tongue and mouth surfaces can feel tiny particles. Creamy appearance means that the product appears smooth, homogeneous, and yet flows. Gritty (or mealy) appearance means that the product appears rough, heterogeneous, and yet flows. Pulpy appearance means that the product appears to have fibrous strands. Sedimentation and separation appearance means that the product appears to be in layers, usually one layer darker or more opaque than another layer. Thickness means that the product moves when force is applied. The thicker (more viscous) the product is, the more force is needed to move the product. Spongy means that the product is semi to solid, but flexible in that pressure deforms the product (usually while expelling liquid). Pasty (or smeary) means fluffy looking, but able to be smoothed into a more concentrated and thinner layer. Fluffy means light, airy mouthfeel and appearance. Toasted means brown notes such as from caramelization of sugar, not burnt. Beany describes the characteristic tastes of lentils, reminiscent of green beans or raw green vegetables, not to be confused with the taste of soybeans. Sharp means strong or pungent flavor that is tasted immediately. Rubbery means flexible, bendable, can be compressed and the texture returns.

Pea fiber as used in this pea fiber product is made up of bundles of polysaccharide molecules of different lengths, some of which are branched. Many of these lengths of polysaccharide (polymers of glucose units) are physically intertwined as the pea plant produces them. Many of these lengths of polysaccharide also align with each other as they are created by the pea plant and bond with each other through their hydroxyl groups. When the pea hull fiber is separated from the pea center during milling, the resulting pea hull fiber molecules may be broken (in length), yet still physically intertwined with each other in bundles. Milling creates an assortment of particles with bundles of a variety of sizes. Milling to finer particle size will decrease the size of the polysaccharide molecules, though intertwining and molecule-to-molecule bonds will still exist in the smaller particles.

An alternative source of fiber from the pea is the fiber milled from the interior of the pea seed. This fiber is physically in long, entangled polysaccharide molecules in bundles, similarly to the fiber sourced from the pea hull.

Depending on milling conditions, the milled fiber containing material could contain a range of protein and starch content. The pea fiber product of this invention has at least 45 dwt. % fiber, preferably 70 dwt. % fiber, most preferably 90 dwt. % fiber. Of this dietary fiber at least 5 dwt. % fiber is soluble, preferably 10 dwt. % is soluble, most preferably 20 dwt. % is soluble. The pea fiber product of this invention has not more than 15 dwt. % protein, preferably not more than 10 dwt. % protein.

This bonding between long polysaccharide molecules can lead to a physical matrix forming within an environment of excess water. The amount of matrix formed by polysaccharides is a balance between the concentration of water and concentration of long polysaccharide molecules (their proximity creating more matrix forming interactions) and reactivity of the polysaccharide molecules (available reactive units to reacting with reactive units of neighbors). Heat and shear applied to a fiber material, especially in the presence of water will create shorter polysaccharide molecule lengths, as well as break weak bonds between polysaccharide molecules.

Water both strongly and weakly bonds to polysaccharides. Water can bond tightly to the hydroxyl groups on polysaccharides. Water can weakly bond to tightly bound water, to polar and hydrophilic areas of polysaccharide molecules and bundles of polysaccharides. Water can also be trapped within polysaccharide structures: both ordered matrixes and just open spaces in expanded polysaccharide bundles. By this theory, the more that the polysaccharide (i.e., fiber) structure is expanded and the polysaccharide lengths are broken, the more water will be influenced (e.g., absorbed, controlled) by that polysaccharide structure.

An example of the influence of fiber on water is the effect of fiber in beverage mixes. In beverages mixes there are solids (including but not limited to proteins, starches, and flavors) that the consumer adds water to and shakes to distribute the solids throughout the water. The desire of the consumer (and of course the manufacturer) is to have the solids remain in suspension during the entire time of consumption, be that immediate and up to 24 hours after shaking. With most beverage mixes, the solids do not stay in suspension as they are heavier than water molecules (so the solids sink), they are bigger than water molecules (so the solids slide past water as they sink), and they are only weakly bond to water (so solids lack bonding with water stronger than the pull of gravity).

The goal of a fiber product manufacturer would be to create a fiber product that can interact with water so that the fiber and the other solids in the beverage mix remain suspended immediately after dispersion and also at least 24 hours after dispersion. Surprisingly, the inventors have created a process for making a fiber product that can do this.

In sauce products, solids are added to water and heated to create a fluid product of the texture desired by a consumer (and manufacturer) in a final food product, such as a gravy, white sauce, tomato based sauce, cooking sauce (e.g., sweet and sour sauce), soup, and stew. The major characteristic of these sauce products is the creation of a thickness and texture that can be maintained through storage. Of course, storage could be at ambient temperature, refrigerated temperatures, and/or frozen temperatures depending on the finished product. There is again a suspension of solids in the sauce, but more important to the finished product texture is the building and maintaining of a desired viscosity of the sauce, as well as the visual and mouthfeel texture (e.g., smoothness, creaminess) of the sauce.

The goal of a fiber product manufacturer would be to create a fiber product that can interact with water so that the fiber and the other solids in the beverage mix remain suspended immediately after dispersion, but also the fiber absorbs and interacts with water to the extent necessary to reduce the flow of the sauce mass (i.e., increase viscosity) initially and also for as long as necessary (e.g., storage time at desired storage temperatures). Also, the visual and mouthfeel textures must be of that desired by consumers for that sauce food product. For example, the sauce with the fiber product must have the desired homogeneity in appearance (i.e., smoothness) and the desired particle free homogeneity in mouthfeel (i.e., creaminess). Surprisingly, the inventors have created a process for making a fiber product that can do this.

In bakery products, which are generally low in water content, solids (e.g., protein, starch, fiber) create the bulk of the products and give the products a desired volume (e.g., air cell number and size), desired chewiness (e.g., elasticity and bounce during mastication), desired crunchiness (i.e., both tactile and audible response during first bite and mastication). Water content also effects these desired product characteristics. Many consumers are trained on a lifetime of consuming bakery products produced with gluten containing wheat flour, which produces desirable volume, chewiness, and crunchiness. The difficulty for many consumers (and of course manufactures) is finding an alternative to this texture creating gluten.

The goal of a fiber manufacturer would be to create a fiber product that can absorb and/or bind with the available water in the bakery product (like gluten traditionally does) and manage the water in that bakery product as it is being baked (e.g., during air cell development, and crisp surface development through evaporation) and after the baked product cools and is stored for a desired amount of time at desired storage temperatures. Surprisingly, the inventors have created a process for making a fiber product that can do this.

In vegetable and/or lentil based meat analogs, such as black bean burgers, which usually have a mid-level water content, solids (e.g., protein, starch, fiber) are used to supply the binder to added beans as well as to create a chewable mass between the beans. Fiber can bind with water and create a paste that surrounds the beans and fills in between beans. The fiber must be able to absorb water that exudes from the beans and must maintain the desired chewy texture immediately upon production and after a desired length of storage at a desired storage temperature. Surprisingly, the inventors have created a process for making a fiber product that can do this.

Using creative processing conditions, the inventors have discovered that processing pea fiber material (hull or interior fiber, preferably hull fiber) that contains at least 45 dwt. % fiber, preferably at least 70 dwt. % fiber, most preferably at least 90 dwt. % fiber in a heating apparatus at about 80 C to about 200 C F under a pressure of about 150 to about 350 PSI with shear creates a pea fiber product with unique and advantageous water absorption and water management abilities. Not to be limited by theory, this treatment of pea fiber material under heat, shear, and pressure appears to create polysaccharide molecules with more reactivity with water, possibly through the development of more reactive sites along the fiber molecules and at the ends of shortened (e.g., broken) polysaccharide molecules. Not to be limited by theory, the process of heat with pressure and shear could be breaking some polysaccharide-to-polysaccharide bonds and breaking some polysaccharide molecules into smaller lengths, both of which would make more hydroxyl groups available for binding with polysaccharide molecules and water.

In an embodiment of the process of this invention, the process for producing the pea fiber product contains two major steps: 1) creating a pea fiber intermediate material by removing through milling the hull from the pea seed center such that the fiber intermediate material contains at least 45% dwt. fiber; or creating a pea fiber intermediate product by removing through milling the fiber molecules from the pea center such that the fiber intermediate material contains at least 45 dwt. % fiber; and 2) creating the pea fiber product of the invention through heating the pea fiber intermediate material to about 80 C to about 200 C under pressure of about 150 to about 350 PSI with shear in a heating apparatus (e.g., extruder). Preferably the fiber intermediate material contains at least 70 dwt. % fiber, more preferably the fiber intermediate material contains at least 90 dwt. % fiber. Most preferably the pea fiber product of this invention has at least 45 dwt. % pea fiber, preferably at least 70 dwt. %, most preferably 90 dwt. % fiber of which at least 5 dwt. % fiber is soluble, preferably at least 10 dwt. % is soluble, most preferably at least 20 dwt. % is soluble. The resultant pea fiber product is such that it has a same day viscosity of 300-1100 cp at 15 wt. % concentration and of 2150-2950 cp at 17 wt. % according to viscosity Test A run at 30 RPM; and has a 60 hour viscosity of 1420-2220 cp at 15 wt. % concentration and of 6400-7200 cp at 17 wt. % concentration according to viscosity Test A. Preferably, the pea fiber material meets USDA Organic Certification requirements. Preferably, the pea fiber material meets FDA non-GMO requirements.

Producing an at least 45 dwt. % protein pea fiber intermediate material from peas (hull or interior pea) can be done by several different processes known by those who practice in this art of milling. The specific method chosen does not limit the scope of this invention. In general, the process includes wet or dry milling.

In an embodiment of the process of this invention, the process starts with supplying a ground pea fiber intermediate material by finely grinding pea fiber material (preferably, pea hull fiber) that was removed from pea seeds to a fine particle size (preferably, 90% through #4 US mesh sieve). This ground pea fiber intermediate material has a content of greater than 45 dwt. % fiber (as measured by AOAC dietary fiber method 991.43) and less than 15 dwt. % protein, preferably less than 10 dwt. % protein. Most preferred, the ground pea fiber intermediate material content is greater than 90 dwt. % fiber. The preferably fine particle size increases the ease and efficiency of the mixing and heating processes in the heating apparatus (e.g., extruder). The fine particle size aids faster hydration of the ground pea fiber intermediate material in the heating apparatus. No conditioning of the ground pea fiber intermediate material is required before its addition to the heating apparatus, though a fiber intermediate material moisture content of about 5 to about 40% is preferred. Moisture content of the fiber intermediate material can be altered by addition of water to create an optimum flow rate dependent on the heating apparatus design and the temperatures and pressures applied.

The heating apparatus used to produce the finished fiber product of this invention can be an extruder with at least one rotating screw (i.e., a shaft holding several blade or pin screw units) to mix, to convey, to apply shear, and to apply heat to the ground fiber intermediate material. The heating apparatus comprises an inlet port, a first section for premixing or preconditioning, a barrel holding one or two screws for mixing and heating, and an exit port with a die. The barrel has several different zones, including an initial material transfer zone, a melting (i.e., heating and mixing) zone, and a melted material transfer zone (i.e., transferring to exit port and die). This invention is not limited by the number of heating and conveying zones in the barrel of the heating apparatus used to make the product of this invention. The barrel would be jacketed so that the barrel, and thus the material within the barrel, would be heated by steam. The barrel could be heated via electricity or hot air also. Also, steam could be directly applied to the material in the barrel, as long as the water content of the material in the extruder does not become greater than 40 wt. %.

Either a single screw or a twin screw extruder could be used to make the fiber product of this invention. The preferred twin screw configuration is used to make the example Samples of this invention. Based on the relative positions of the two parallel screws within the barrel of the extruder, there were four types of screw configurations available for this extruder: co-rotating intermeshing, co-rotating non-intermeshing, counter-rotating intermeshing, and counter-rotating non-inter-meshing. Any configuration could be used to make the fiber product of this invention, but the co-rotating intermeshing twin-screw was and is preferred and was used to make the example Samples of this pea fiber product invention. A single screw could also be used to make the fiber product of this invention at a lower equipment cost, but a twin screw extruder is preferred due its greater mixing and shear application capabilities.

Other heating apparatus formats could be used, such as a mixer (bowl or cylinder, vertical or horizontal) with a “S” or a “Z” mixing blade or a screw arrangement as long as the material within the apparatus could be heated to the required temperatures and pressures while the material is mixed and forced through an exit port that contains a die.

Preferably, all of the process steps of mixing, heating, and expansion can be done with one apparatus.

Feed rate of the pea fiber intermediate material going into the heating apparatus can cause an impact on the overall nature of the finished pea fiber product of this invention. The feed rate affects the residence time, torque, and pressure inside the heating apparatus as well as the temperature of the pea fiber intermediate material in the heating apparatus.

In an embodiment of the process of this invention, finely ground pea fiber intermediate material was converted into the final pea fiber product of this invention through the steps of: 1) mixing and optionally preconditioning the finely ground pea fiber intermediate materials with additional water, so that the preconditioned pea fiber intermediate material has no more than 40 wt. % water content; 2) adding the preconditioned ground fiber intermediate material to a first zone of the heating apparatus through an inlet port at one end of the apparatus; 3) mixing and conveying the fiber intermediate material to a heating zone at a screw rotational speed of about 300 to about 800 revolutions per minute, 4) mixing and heating the fiber intermediate material to no greater than 200 C in this heating zone, 5) conveying the heated ground fiber intermediate material to a second heating and transferring zone; 6) mixing and heating the ground fiber intermediate material in the transfer zone; 7) conveying the heated ground fiber intermediate fiber from the transfer zone and out of the heating apparatus through the exit port and die at a temperature between about 80° C. and about 200° C. and a pressure of about 150 and about 350 PSI; 8) expanding the heated fiber intermediate material as it exits the die into ambient temperature and atmosphere environment; 9) cutting the expanded ground fiber intermediate material into pieces; and 10) cooling the cut expanded material into pieces of final pea fiber product. Feed rate of the pea fiber intermediate material was feed at a rate not less than 50 lb/hour, preferably not less than 100 lb/hour, more preferably not less than 250 lb/hour. The expanded pieces of fiber material were additionally dried to not more than 20 wt. % water, preferably not more than 15 wt. % water, most preferably not more than 5 wt. % water to make extruded crisps of the final pea fiber product of this invention. Some of the expanded pieces of fiber material were additionally ground into a powder after the expanded pieces cooled to ambient temperature and optionally dried to make the final pea fiber product in powder form of this invention. This invention (product, process, and uses thereof) is not limited by the final form (i.e. expanded pieces or ground pieces). Though the powder form of the final pea fiber product was used to make food products, (e.g. sauces, bakery, beverages, meat analogs, and aerated desserts and confectionary) the expanded pieces (i.e. not ground to powder) would be expected to have similar water absorption and water management and physiochemical properties.

In the process of making an example of the pea fiber product of the invention, the heat, shear, and pressure applied to the pea fiber intermediate material in the heating apparatus thermo-mechanically transformed the pea fiber intermediate material into the pea fiber product of this invention with enhanced functionality.

During the mixing and heating under shear and pressure within the heating apparatus, the water and components of the pea fiber intermediate material (including its fiber, protein, and starch components) intermix, soften, and at least in part, melt (i.e., become fluid, amorphous, glass, and/or gelatinized). Due to the heat and shear application within the barrel, energy in the mass increases and the materials become more fluid and reactive to each other and to water molecules. At least some of the molecules in the pea fiber intermediate material are shortened in length during mixing (due to shear), expanding (due to stretching to breaking point), and grinding (due to physical breaking) steps of the process of this invention.

As the water becomes hotter in the barrel, especially when the barrel is under pressure, water accumulates energy that exhibits itself as steam that expands and flashes off when the heated, wet, fiber intermediate material exits the die. In doing such, the entire heated mass expands as it exits the die. Expanding physically stretches the fiber, protein, and starch molecules as rubber molecules in a balloon are stretched when internal pressure grows within in it. Like the rubber of balloon, at least some of the molecules of pea fiber intermediate material broke under stress of expansion. Expansion puts space between the many molecules of fiber, protein, and starch of the heated fiber material. This creates more available reaction sites along the various molecules of the fiber, protein, and starch of the ground pea fiber intermediate material, as well as of the final pea fiber product of this invention. After exiting the die into ambient temperature and pressure environmental conditions, the water in the heated mass converts from steam to liquid and the heated expanded pea fiber intermediate material quickly cools. Under the formulation and process steps of this invention, the heated intermediate material maintains its expanded form when the expanded mass cools to ambient temperature and pressure.

Not to be bound of limited by theory, the cooled expanded form of the fiber material still has more space between the many molecules of fiber, protein, and starch, that provides more reactive sites along their molecules than were present before the fiber intermediate material entered the heating apparatus.

Not to be bound or limited by theory, the heating of the ground pea fiber intermediate material (which includes predominantly fiber, but also some protein and starch molecules) in the heating apparatus under shear and pressure, as well as the grinding of the extruded material, does cause some physiological changes to the fiber, protein, and starch molecules. An example of such changes include starch gelatinization, causing an increase in starch solubility. Another example of such changes include protein stretching and strengthening causing an increase in the hydrophobic nature of the protein, creation of access to additional molecule reactive sites, as well as possibly denaturing of the protein. Another example is fiber breaking and opening its structure to create additional molecular reactive sites which could cause an increase in solubility.

Water is an important factor in the success of the process of this invention. Moisture has several functions in extrusion. The first function is it acts a plasticizer and helps to create a soft dough to achieve the necessary characteristics in the final product. The second function of moisture is to act as a source of water to gelatinize starch and to break protein down. Third function of moisture is to act as a lubricant during extrusion that lubricates the screw to manage the amount of friction imparted to the fiber mass in terms of mechanical energy. Finally moisture is an expansion aid during extrusion. Water content in the example process of this invention described above was controlled so as to be no more than 40% moisture content during extrusion

In an embodiment of this invention the pea fiber product of this invention was used in making food products wherein some part of the food product production process includes the making of a high water content sauce with pea fiber product content of at least 1 wt. %, 5 wt. %, 13 wt. %, 15 wt. %, 17 wt. %, 20 wt. %, or 23 wt. %.

In an embodiment of this invention the pea fiber product of this invention was used in making food products wherein some part of the food product production process includes the making of a intermediate product containing from 3-80% water and 97-20% pea protein product.

In an embodiment of this invention the pea fiber product of this invention was used in making food products wherein some part of the food product production process includes the combining of the pea fiber product with other non-water ingredients before water is combined with the pea fiber product.

In an embodiment of this invention the pea fiber product of this invention was used in making food products wherein some part of the food product production process includes the combining of ingredients wherein the ratio of pea fiber product to water in the combination of ingredients is 1:9, 2:8, 3:7, 4:6, 7:3, 8:2, or 9:1.

In an embodiment of this invention the pea fiber product of this invention was used in making food products wherein the water content of the food product does not change in water content by more than 5 wt. %, 10 wt. %, or 15 wt. % during storage at ambient, refrigerated, or frozen temperatures for 24 hours, for 48 hours, for 80 hours, or for 2 months.

In an embodiment of this invention the pea fiber product of this invention was used in making food products wherein some part of the food product production process includes the making of a intermediate product containing 3-80% water and 97-20% pea fiber as measured by AOAC method 991.43.

In an embodiment of this invention the pea fiber product of this invention is used in a beverage, preferably at greater than about 1, 5, 10, 12, 15, 20, 25, 30, or 40 wt. % of the beverage, most preferably at 1, 5, 10, 12, 15, 20, 25, 30, or 40 dwt. % of the beverage.

In an embodiment of this invention the term beverage includes, but is not limited to liquid high water content food products that are carbonated or noncarbonated, condensed or single strength, fruit or savory flavored, with or without sensients, and with or without nutritional claims. These beverages could also be in the form of dry mixes which are hydrated by the consumer or manufacturer.

In an embodiment of this invention the pea fiber product of this invention is used in a sauce, preferably at greater than about 1, 5, 10, 12, 15, 20, 25, 30, or 40 wt. % of the sauce, most preferably at 1, 5, 10, 12, 15, 20, 25, 30, or 40 dwt. % of the sauce.

In an embodiment of this invention the term sauces includes, but is not limited to liquid food products, or mixes that consumers add water to, includes but is not limited to gravies, white sauces, savory sauces, sweet sauces, cooking sauces, tomato based sauces, marinades, dressings and combinations thereof.

In an embodiment of this invention the term bakery includes, but is not limited to cookies, crackers, cakes, muffins, waffles, pancakes, ice cream cones, tortillas, chips, snack crackers, pretzels, extruded or puffed snacks, and bread (chemically and yeast leavened).

In an embodiment of this invention the pea fiber product of this invention is used in a bakery product, preferably at greater than about 1, 5, 10, 12, 15, 20, 25, 30, 40, 50, 60, 70, 80, 90, or 95 wt. % of the product, most preferably at 1, 5, 10, 12, 15, 20, 25, 30, 40, 50, 60, 70, 80, 90, or 95 dwt. % of the product.

In an embodiment of this invention the pea fiber product of this invention is used in an aerated dessert or confectionary product, preferably at greater than about 1, 5, 10, 12, 15, 20, 25, 30, 40, 50, or 60 wt. % of the product, most preferably at 1, 5, 10, 12, 15, 20, 25, 30, 40, 50, or 60 dwt. % of the product.

In an embodiment of this invention the term aerated dessert or confectionary product includes, but is not limited to mousse, ice cream, frozen yogurt, frappe, meringue, nougat, icing, whipped topping, and whipped cream products.

In an embodiment of this invention the pea fiber product of this invention is used in a meat analog product, preferably at greater than about 1, 5, 10, 12, 15, 20, 25, 30, 40, 50, 60, 70 or 80 wt. % of the product, most preferably at 1, 5, 10, 12, 15, 20, 25, 30, 40, 50, 60, 70 or 80 dwt. % of the product.

In an embodiment of this invention the term meat analogue product includes, but is not limited to vegetable and lentil (i.e. peas and beans) based mixes, patties, loaves, or pieces used as substitutes for ground or chunked meat.

In an embodiment of this invention, beverages, sauces, bakery, and aerated desserts and confectionary products include with the pea fiber product of this invention bulking ingredients, as well as flavoring ingredients. Bulking ingredients to be included in the sauces and/or beverages include, but are not limited to starches, fibers, other proteins, hydrocolloids, and celluloses. Bulking ingredients refers to ingredients that provide mass and structure. Flavoring ingredients to be included in the sauces and/or beverages include, but are not limited to sweeteners, acids, salts, fruit based ingredients, spices, and flavors.

### EXAMPLES

### Example: Process for Making Pea Fiber Product

The heating apparatus used to make an example of the pea fiber product of this invention was a Wegner 57 (TX-57) mm twin screw extruder, which was composed of several different zones, including a material transfer zone, a melting zone and a melted material transfer zones. Table 1 lists the other processing conditions used in this example of the process of this invention. This extruder also had an inlet on one end of the extruder and an exit port with a die on the opposite end of the extruder. The preferred co-rotating intermeshing twin-screw extruder configuration was used in this example of the process of making the pea fiber product of this invention. The feed rate used in the example of the process of this invention was not less than 150 lbs/hour of pea intermediate material through the extruder.

TABLE 1
Process Example Equipment/Process Conditions

| Parameter | Result | |
|---|---|---|
| Feed Rate | 150-200 | lbs/hr |
| Screw RPM | 300-500 | RPM |
| Steam Flow | 6.5-8.0 | lbs/hr |
| Water Flow | 60-80 | lbs/hr |
| Knife Setup | 3-10 | Flex |
| Knife Speed (RPM) | 1350-1900 | RPM |
| Head #4 Temp | 145-170 | C. |
| Head #3 Temp | 130-160 | C. |
| Head #2 Temp | 100-150 | C. |
| Head #1 Temp | 50-95 | C. |
| Head Pressure | 150-350 | PSI |
| Extruder Discharge Density (g/640 mL) | 200-300 | |

### Example: Pea Fiber Product

A pea fiber product in accordance with the present invention was produced according to the process of Example Process using the process conditions in Table 1. The resultant pea fiber product (Sample A) contained 48% fiber and 14% protein and had a same day viscosity of 300-1100 cp at 15 wt. % concentration and of 2150-2950 cp at 17 wt. % according to viscosity Test A run at 30 RPM; and had a 60 hour viscosity of 1420-2220 cp at 15 wt. % concentration and of 6400-7200 cp at 17 wt. % concentration according to viscosity Test A.

Viscosity Test A was conducted on Samples of the pea fiber product of this invention and on Samples of the ground, native, and pea fiber (i.e. intermediate pea fiber material) used to make the Samples of pea fiber product.

TABLE 2
Viscosity results (cp) from Test A (+/− 400 cp)

| | Initial | | 60 hours | | 84 hours | |
|---|---|---|---|---|---|---|
| | 12 RPM | 30 RPM | 12 RPM | 30 RPM | 12 RPM | 30 RPM |
| A-15% | 100 | 700 | 5250 | 1820 | 3000 | 2000 |
| A-17% | 4000 | 2550 | 10400 | 6800 | 11000 | 4000 |
| B-15% | 2550 | 1900 | 3400 | 2800 | 4000 | 1900 |
| B-17% | 10250 | 3850 | 13000 | 8000 | 10250 | 3450 |

TABLE 3
Observations for Test A.

| | Initial | 60 hours | 84 hours |
|---|---|---|---|
| A-15% | Thick Mashed | Some syneresis, | Pourable, white film, Lot |
| | Potato | foamy, soft | of syneresis and |
| | consistency | | separation |
| A-17% | Thick Mashed | Air pocket | Lot of syneresis, |
| | Potato | development, | moderately thick, smooth |
| | consistency | mild syneresis | consistency |
| B-15% | Wallpaper | Moderate syneresis, | Very wet, fermentation, |
| | paste | foamy, soft | Heavy Syneresis |
| | consistency | | |
| B-17% | Wallpaper | Fermentation, | Fermentation, lots of air |
| | paste | minimal | pockets |
| | consistency | syneresis | |

The functional characteristic measured in Test A was viscosity. In Test A, each of the pea fiber product Samples (A,B) were made into 15 and 17% solutions with water and evaluated same day, after 60 hours of storage, and after 84 hours of storage. Samples A and B were commercial products of PURIS (Oskaloosa Iowa): CYP-CP (Sample A) and CYP-RP (Sample B). Sample A was produced according to the process of this invention.

Viscosity Test A: Water was heated to about 100° C. (boiling) on a stove top and then removed from the heat source. Pea Fiber Product was whisked into the water for three-five minutes depending on dispersability. The Samples were allowed to cool to room temperature before being divided into seven identical containers per Sample (A, B) with (3) being kept at room temperature, (2) being kept at refrigeration temperature (34° F.), and (2) being held in freezing conditions (0° F.) per Pea Fiber Product type. One Sample per Pea Fiber Product type was analyzed immediately utilizing a Brookfield Viscometer Model Number 35512 supplied by Brookfield Ametek utilizing spindle LV 4 at 12 and 30 RPM. Sample readings were taken from the Brookfield dial after running (rotating) for 5 revolutions, per equipment manual recommendation. This process was repeated with each Sample held at room temperature, refrigerated and frozen for sixty hours and for 84 hours. Samples were brought to room temperature before being analyzed using the Brookfield under the parameters previously stated. Sample A (pea fiber product according to this invention) produced a much thinner product initially but ended with a viscosity close to that of Sample B. Sample A was a thinner, and had the consistency of thick instant mashed potatoes whereas Sample B was extremely thick and resembled wallpaper paste. After 60 and 84 hours, both Samples were beginning to ferment and separate.

### Example: Sauces Using Pea Fiber Product

Sauce Experiment 1

Objective: To determine the effects of Sample A and Sample B mixed with water at various concentrations.

Results

TABLE 4
Preparation of solutions 15%, 17% & 20% (pea fiber product in water)
were prepared utilizing the same method for both Sample A and
Sample B utilizing the following ratios.

| Fiber Type | Ratio | % fiber | % water | Actual % fiber (± 5%) |
|---|---|---|---|---|
| Sample A | Low | 15 | 85 | 8.25 |
| | Medium | 17 | 83 | 9.35 |
| | High | 20 | 80 | 11 |
| Sample B | Low | 15 | 85 | 8.25 |
| | Medium | 17 | 83 | 9.35 |
| | High | 20 | 80 | 11 |

Fiber and water were weighted utilizing a calibrated scientific scale to the hundredth place (0.01). Water was then heated to 100° C. before adding the fiber. Solution was whisked for three minutes before being divided into eight plastic containers with the following labels in Table 5. Samples A and B were commercial products of PURIS (Oskaloosa Iowa): CYP-CP (Sample A) and CYP-RP (Sample B). Sample A was produced according to the process of this invention.

TABLE 5
Sauce Experiment 1 Variations and Explanations.

| Experiment | Description |
|---|---|
| Sample A - 0 hrs. 70° | Sample A, Initial Prep Room Temperature |
| Sample A 60 hrs. 0° | Sample A, Frozen for 60 hours |
| Sample A 60 hrs. 30° | Sample A, Refrigerated for 60 hours |
| Sample A 60 hrs. 70° | Sample A, Room Temperature for 60 hours |
| Sample A 84 hrs. 0° | Sample A, Frozen for 84 hours |
| Sample A 84 hrs. 30° | Sample A, Refrigerated for 84 hours |
| Sample A 84 hrs. 70° | Sample A, Room Temperature for 84 hours |
| Sample B 0 hrs. 70° | Sample B, Initial Prep Room Temperature |
| Sample B 60 hrs. 0° | Sample B, Frozen for 60 hours |
| SAMPLE B 60 hrs. 30° | Sample B, Refrigerated for 60 hours |
| SAMPLE B 60 hrs. 70° | Sample B, Room Temperature for 60 hours |
| Sample B 84 hrs. 0° | Sample B, Frozen for 84 hours |
| Sample B 84 hrs. 30° | Sample B, Refrigerated for 84 hours |
| Sample B 84 hrs. 70° | Sample B, Room Temperature for 84 hours |

The same solution was then utilized to obtain two viscosity readings from a Brookfield Dial Reading Viscometer LV with LV 4 spindles at 12 and 30 rpm. This evaluation was repeated twice and results were recorded in Table 6. Samples were refrigerated and frozen for 60 hours and 84 hours. Results can be seen in Table 6.

Experiment 2 Method: Experiment 1 was repeated with a 10% solution of fiber and water. Spindles and speeds remained the same. Times of evaluation changed from 60 and 84 hours to 84 and 96 hours. The Bostwick Consistometer was also utilized in this experiment to compare the flow rates of the different fibers.

Results from Sauce Experiment 1 and 2

TABLE 6
Sauce Experiment 1, Results values in viscosity (cp).

| | 12 RPM | 12 RPM | 30 RPM | 30 RPM | Notes |
|---|---|---|---|---|---|
| Sample A 0 hrs. | 100 | 100 | 700 | 700 | Thick mashed potato consistency |
| 70° 15% | | | | | |
| Sample A 0 hrs. | 3750 | 4250 | 2600 | 2500 | Thick mashed potato consistency |
| 70° 17% | | | | | |
| Sample A 0 hrs. | 16500 | 17000 | 10600 | 10500 | Thick mashed potato consistency |
| 70° 20% | | | | | |
| Sample A 60 hrs. | >100 | >100 | >100 | >100 | Looked crystalized like it was still frozen, |
| 0° 15% | | | | | sponge like, solid foam, pasty inside, could |
| | | | | | squeeze water out, chunky when stirred |
| Sample A 60 hrs. | >100 | >100 | >100 | >100 | Same as 15%, same alignment of fiber, |
| 0° 17% | | | | | loosely traps water, more pasty in the center, |
| | | | | | no lines in the bottom unlike 15%, no |
| | | | | | syneresis, short texture, spread but not as |
| | | | | | easily as 15% |
| SAMPLE A 60 hrs. | >100 | >100 | >100 | >100 | A few cracks, firm/hard, fudge like, broke, |
| 0° 20% | | | | | not as short of texture, spreadable, resembled |
| | | | | | mashed potatoes, water remained bound |
| | | | | | when spread |
| Sample A 60 hrs. | >100 | >100 | >100 | >100 | Moderate syneresis, mousse consistency, |
| 30°15% | | | | | light and fluffy, very smooth, cream soup |
| | | | | | consistency when stirred. |
| Sample A 60 hrs. | >100 | >100 | >100 | >100 | Broke when trying to stir, smooth once |
| 30° 17% | | | | | agitated thoroughly, slight separation with |
| | | | | | solid form |
| SAMPle A 60 hrs. | >100 | >100 | >100 | >100 | Slight syneresis, broke when cut, very firm, |
| 30° 20% | | | | | fudge like consistency, more chunky when |
| | | | | | stirred when compared to 17% |
| Sample A 60 hrs. | 5250 | 5250 | 1840 | 1800 | Some syneresis, foamy |
| 70° 15% | | | | | |
| Sample A 60 hrs. | 10600 | 10350 | 6800 | 6860 | Air pocket development, mild syneresis |
| 70° 17% | | | | | |
| Sample A 60 hrs. | >100 | >100 | >100 | >100 | No air pockets, one crack |
| 70° 20% | | | | | |
| Sample A 84 hrs. | >100 | >100 | >100 | >100 | Releases water when pressed, cracks, fiber |
| 0° 15% | | | | | alignment around edges, appears to be a |
| | | | | | crust, tore when cut, mild syneresis, chunky |
| | | | | | when stirred |
| SAmple A 84 hrs. | >100 | >100 | >100 | >100 | Crystallization appearance, fiber alignment, |
| 0° 17% | | | | | firm disc, sponge like, barely any water |
| | | | | | released when pressed, crumbled in large |
| | | | | | chunks when agitated, extremely chunky |
| | | | | | when stirred, |
| Sample A 84 hrs. | >100 | >100 | >100 | >100 | Very minimal cracking, sponge like, fiber |
| 0° 20% | | | | | alignment, very firm, difficult to cut, |
| | | | | | crumbled, didn't stick together, looked like |
| | | | | | cookie dough |
| Sample A 84 hrs. | >100 | >100 | >100 | >100 | A ton of syneresis, gel like top layer, very |
| 30° 15% | | | | | smooth, soft, easily spreadable, smooth |
| | | | | | when agitated, thick custard resemblance |
| Sample A 84 hrs. | >100 | >100 | >100 | >100 | Lots of syneresis, very smooth, gel like top |
| 30° 17% | | | | | layer, didn't release water when pressed, |
| | | | | | resembles cheesecake when cut, made |
| | | | | | smooth paste when stirred |
| Sample A 84 hrs. | >100 | >100 | >100 | >100 | Mild syneresis, rubbery, firm structure, |
| 30° 20% | | | | | bounced back, difficult to paste, hard to cut, |
| | | | | | forms a dough ball |
| Sample A 84 hrs. | 3500 | 2750 | 2600 | 1800 | Pourable, white film, lots of syneresis and |
| 70° 15% | | | | | separation, |
| Sample A 84 hrs. | 12750 | 10500 | 6600 | 3200 | Lots of syneresis, fermentation moderately |
| 70° 17% | | | | | thick, smooth |
| Sample A 84 hrs. | >100 | >100 | >100 | >100 | Pungent smell, thick, cracked along sides, |
| 70° 20% | | | | | shiny, fermented, air pockets, smooth yogurt |
| | | | | | consistency when stirred. |
| Sample B 0 hrs. 70° | 2600 | 2500 | 1900 | 1900 | Wallpaper paste consistency |
| 15% | | | | | |
| Sample B 0 hrs. 70° | 10500 | 10000 | 6900 | 6800 | Wallpaper paste consistency |
| 17% | | | | | |
| Sample B 0 hrs. 70° | 31000 | 30750 | >100 | >100 | Wallpaper paste consistency |
| 20% | | | | | |
| Sample B 60 hrs. 0° | >100 | >100 | >100 | >100 | Mild syneresis, air pocket formation |
| 15% | | | | | |
| Sample B 60 hrs. 0° | >100 | >100 | >100 | >100 | Tons of compressed air, minimal separation |
| 17% | | | | | |
| Sample B 60 hrs. 0° | >100 | >100 | >100 | >100 | Compressed air in container, air pockets |
| 20% | | | | | |
| Sample B 60 hrs. | >100 | >100 | >100 | >100 | Air bubbles, syneresis, scoop-able, water on |
| 30° 15% | | | | | bottom, less internal structure, didn't mush, |
| | | | | | releases water as stirred, shiny |
| Sample B 60 hrs. | >100 | >100 | >100 | >100 | No surface alignment, lots of bubbles, top |
| 30° 17% | | | | | surface cuts well, no surface water on top or |
| | | | | | bottom, did not release water when smashed, |
| | | | | | play-doh resemblance, dull |
| Sample B 60 hrs. | >100 | >100 | >100 | >100 | Not as smooth, dull, crust on top, dry, |
| 30° 20% | | | | | resembles mashed potatoes, smoothed out |
| | | | | | like 20% Sample A, no alignment, didn't |
| | | | | | flatten out |
| Sample B 60 hrs. | 3445 | 3400 | 2700 | 2820 | Moderate syneresis, foamy |
| 70° 15% | | | | | |
| Sample B 60 hrs. | 13050 | 12800 | 8500 | 7400 | Fermentation, minimal separation |
| 70° 17% | | | | | |
| Sample B 60 hrs. | >100 | >100 | >100 | >100 | Air pockets, syneresis |
| 70° 20% | | | | | |
| Sample B 84 hrs. 0° | >100 | >100 | >100 | >100 | Acted like a sponge, slight syneresis, air |
| 15% | | | | | bubbles, wet oatmeal appearance, chunky |
| | | | | | once stirred |
| Sample B 84 hrs. 0° | >100 | >100 | >100 | >100 | Tightly bound water, solid disc, a few |
| 17% | | | | | cracks, broke, thick mashed potato |
| | | | | | consistency, smearable |
| Sample B 84 hrs. 0° | >100 | >100 | >100 | >100 | Very firm, no water released when pressed, |
| 20% | | | | | broke when cut, dry, crumbled when stirred. |
| SAMPLE B 84 hrs. | >100 | >100 | >100 | >100 | Lots of syneresis, air bubbles, water on |
| 30° 15% | | | | | bottom too, very soft, didn't hold water, |
| | | | | | shiny, resembles baby food |
| SAMPLE B 84 hrs. | >100 | >100 | >100 | >100 | Slight syneresis, a few air bubbles, shiny, |
| 30° 17% | | | | | soft but firm, mashed potato consistency, |
| | | | | | very smooth when stirred |
| SAMPLE B 84 hrs. | >100 | >100 | >100 | >100 | Slight syneresis, a few air bubbles, looked |
| 30° 20% | | | | | lighter/fluffier, very firm, very thick pasty |
| | | | | | mashed potato consistency, |
| SAMPLE B 84 hrs. | 4250 | 3750 | 2000 | 1800 | Very wet, fermented, lots of syneresis, very |
| 70° 15% | | | | | liquidly |
| SAMPLE B 84 hrs. | 10500 | 10000 | 3400 | 3500 | Fluffy, fermented, lots of air pockets, rancid |
| 70° 17% | | | | | smell |
| SAMPLE B 84 hrs. | >100 | >100 | >100 | >100 | Thick, fluffy, fermented, mashed potato |
| 70° 20% | | | | | consistency |

Sauce Experiment 2: Viscosity of Sauces

Objective: To determine the differences in consistency between Sample A and Sample B using a Bostwick Consistometer.

Table 5: Analysis of 15% and 20% solutions of both fiber types were analyzed utilizing a Bostwick Consistometer at 5, 30 and 60 seconds.

TABLE 7
Sauce Experiment 2: Results from Bostwick Viscometer test.

| Fiber | % Fiber | 5 seconds | 30 seconds | 60 seconds |
|---|---|---|---|---|
| Sample A | 15 | >24 | >24 | >24 |
| Sample B | 15 | 17.5 | >24 | >24 |
| Sample A | 20 | 14 | 17 | 18.5 |
| Sample B | 20 | 5 | 6.5 | 7 |

Sauce Conclusions:

Sample A (pea fiber product of this invention) absorbs water differently than Sample B (pea fiber intermediate material). Sample A bound water within the inner and outer cell structures which resulted in a sponge like structure when frozen and refrigerated. This sponge like structure would release water when pressure was added and retract it when released. This occurred in nearly all of the Sample A trials that were refrigerated and frozen. This also occurred in Sample B frozen for 84 hours, but at no other time. Sample A had crystal like formations in the frozen and refrigerated trials. This crystallization is beneficial for adding body to products, such as a mousse or ice cream. A minimum limit in which the fiber begins creating solid matrices is between 10 and 15%, not to be limited by theory.

Experiment 2: Meat Analogs

Black Bean Burgers Example

Objective: To determine the effects of Sample A versus Sample B on black bean burgers.

Method: Black Bean Burgers were prepared utilizing the following recipes seen in Table 8. Each recipe was divided into three to form three patties. Each variation was cooked simultaneously on medium-high heat for four minutes on each side.

TABLE 8
Recipe Formulations for Black Bean Experiment

| Recipe Variation | Original Recipe | Experiment Recipe |
|---|---|---|
| Standard Base recipe | 1 (16 ounce) can black beans, | 6.4 ounces of black beans |
| (control) | drained and rinsed | ⅕ onion |
| | ½ onion, diced | ½ egg |
| | 1 egg | ½ Tbsp chili powder |
| | 1 Tbsp chili powder | ½ Tbsp cumin |
| | 1 Tbsp cumin | ¼ cup + 2 Tbsp bread crumbs |
| | ½ cup bread crumbs | 1 Tbsp flour |
| | 2 Tbsp flour | |
| Standard Black Bean | 1 (16 ounce)can black beans, | 6.4 ounces of black beans |
| Burger with Sample A | drained and rinsed | ⅕ onion |
| | ½ onion, diced | ½ egg |
| | 1 egg | ½ Tbsp chili powder |
| | 1 Tbsp chili powder | ½ Tbsp cumin |
| | 1 Tbsp cumin | ¼ cup + 2 Tbsp bread crumbs |
| | ½ cup bread crumbs | 10 grams Sample A |
| | 2 Tbsp flour | |
| Standard Black Bean | 1 (16 ounce) can black beans, | 6.4 ounces of black beans |
| Burger with Sample B | drained and rinsed | ⅕ onion |
| | ½ onion, diced | ½ egg |
| | 1 egg | ½ Tbsp chili powder |
| | 1 Tbsp chili powder | ½ Tbsp cumin |
| | 1 Tbsp cumin | ¼ cup + 2 Tbsp bread crumbs |
| | ½ cup bread crumbs | 10 grams Sample B |
| | 2 Tbsp flour | |
| Breadless Black Bean | 1 (16 ounce) can black beans, | 6.4 ounces of black beans |
| Burger with Sample B | drained and rinsed | ⅕ onion |
| | ½ onion, diced | ½ egg |
| | 1 egg | ½ Tbsp chili powder |
| | 1 Tbsp chili powder | ½ Tbsp cumin |
| | 1 Tbsp cumin | 10 grams Sample B |
| | ¼ cup flour | |
| Breadless Black Bean | 1 (16 ounce) can black beans, | 6.4 ounces of black beans |
| Burger with Sample A | drained and rinsed | ⅕ onion |
| | ½ onion, diced | ½ egg |
| | 1 egg | ½ Tbsp chili powder |
| | 1 Tbsp chili powder | ½ Tbsp cumin |
| | 1 Tbsp cumin | 10 grams Sample A |
| | ¼ cup flour | |

Results:

TABLE 9
Results from Black Bean Burgers from Black Bean Experiment

| | |
|---|---|
| Standard Black | slightly mushy, good flavor, barely crisped on |
| Bean Burger | outside, fell apart, spotty browning |
| Standard Black Bean | very crisp, darker than Sample B, more black |
| Burger with Sample A | notes than brown notes, didn't crumble |
| Standard Black Bean | broke, didn't color, darker browning throughout |
| Burger with Sample B | both sides |
| Breadless Black Bean | held together fairly well but not as good as with |
| Burger with Sample A | bread, browned fairly evenly |
| Breadless Black Bean | more wet, broke a little more |
| Burger with Sample B | |

As seen in Table 9, not to be limited in theory, black bean burgers with Sample A created a burger with much more body, holding capacity, and bite.

Conclusion: Replacing the flour with Sample A or Sample B resulted in firmer burgers with more bite that also had more hold than the standard black bean burger recipe. The Sample A burgers displayed a more definite bite than the Sample B burgers and had a crisper outside. The Sample A burgers also experienced more browning and held together the best. When replacing the flour with fiber and omitting the bread, the Sample A held together better than the Sample B and experienced more browning. With more recipe formulation, it would be reasonably likely that a Gluten Free Black Bean Burger can be made with characteristics comparable to beef burgers and other black bean burgers on the market. By replacing the flour with fiber, the overall fiber content of the burgers are increased along with the added textural benefits.

Biscuit Examples

Objective: To determine the effects of Samples A and B on Bisquick, Gluten Free Bisquick, and PURIS™ Baking Mix.

Biscuit Experiment 1:

Method:

Sample A₂ was the same crisps as Sample A only ground in a burr mill which resulted in a much courser Sample. Sample A₂ and Sample B were added to Bisquick, Gluten Free Bisquick, and PURIS™ Baking Mix. Instructions on the package were followed. Ten grams of each Sample were added to each of the baking mixes with no addition of water. A full list of recipe variations can be seen in Table 10. The appearance, taste, and texture were evaluated immediately after biscuits were finished baking, results can be found in Appendix B. Samples were allowed to rest at room temperature for twelve hours before being sealed in plastic bags. One biscuit of each fiber type and biscuit base were left at room temperature, refrigeration temperature (34° F.) and frozen (0° F.) for 24 hours. Biscuits were reevaluated based on the previous characteristics of appearance, taste, and texture. Biscuits were then placed back in the designated temperature setting for an additional 48 hours before being evaluated for a final time based on appearance and texture.

TABLE 10
Biscuit Experiment 1 recipe variations.

| Bisquick | Gluten | PURIS ™ Baking Mix |
|---|---|---|
| (Control) | Free Bisquick (Control) | (Control) |
| Bisquick + | Gluten Free Bisquick + | PURIS ™ Baking Mix + 10 g |
| 10 g Sample | 10 g Sample A₂ | Sample A₂ |
| A₂ | | |
| Bisquick + | Gluten Free Bisquick + | PURIS ™ Baking Mix + 10 g |
| 10 g Sample B | 10 g Sample B | Sample B |

Biscuit Experiment 2 Method

As in Experiment 1, ten grams of fiber were added to Bisquick, Gluten Free Bisquick, and PURIS™ Baking Mix. A full list of recipe deviations can be seen in Table 2.

TABLE 1
Experiment 2 recipe variations.

| | | PURIS ™ Baking Mix |
|---|---|---|
| Bisquick (Control) | Gluten Free Bisquick (Control) | (Control) |
| Bisquick + 10 g Sample A | Gluten Free Bisquick + 10 g | PURIS ™ Baking Mix + 10 g |
| | Sample A | Sample A |
| Bisquick + 10 g SAMPLE B | Gluten Free Bisquick + 10 g | PURIS ™ Baking Mix + 10 g |
| | Sample B | Sample B |
| Bisquick + 10 g SAMPLE | Gluten Free Bisquick + 10 g | PURIS ™ Baking Mix + 10 g |
| A + 2 Tbsp water | Sample A + 2 Tbsp water | Sample A + 2 Tbsp water |
| Bisquick + 10 g SAMPLE | Gluten Free Bisquick + 10 g | PURIS ™ Baking Mix + 10 g |
| A + ¼ c water | Sample A + ¼ c water | Sample A + ¼ c water |
| Bisquick + 10 g SAMPLE | Gluten Free Bisquick + 10 g | PURIS ™ Baking Mix + 10 g |
| B + 2 Tbsp water | Sample B + 2 Tbsp water | Sample B + 2 Tbsp water |
| Bisquick + 10 g SAMPLE | Gluten Free Bisquick + 10 g | PURIS ™ Baking Mix + 10 g |
| B + ¼ c water | Sample B + ¼ c water | Sample B + ¼ c water |

The appearance, taste, and texture were evaluated immediately after biscuits were finished baking, results can be found in Table 11. Samples were allowed to rest at room temperature for twelve hours before being sealed in plastic bags. One biscuit of each Sample and biscuit base were left at room temperature, refrigeration temperature (34° F.) and frozen (0° F.) for 24 hours. Biscuits were reevaluated based on the previous characteristics of appearance, taste, and texture.

Results Biscuit Experiments 1 and 2

Experiment 1:

TABLE 11
Results from Experiment 1; dough appearance, baked appearance, taste and
texture.

| Experiment | Dough Appearance | Baked Appearance | Taste & Texture |
|---|---|---|---|
| Bisquick | Very wet and sticky, | Very dark crust, no | Gummy texture, stuck |
| | unable to form, | consistent | to back of mouth, no |
| | dropped onto baking | shape/formation, | off flavor, crisp initial |
| | sheet | Fluffy appearance, | bite then addition of |
| | | large air pockets, no | saliva made a paste |
| | | cracking | |
| Bisquick + Sample A₂ | Dry, forms dough ball | One biscuit | Crisp outside, slight |
| | when mixing, did not | experienced much | gummy inside texture, |
| | stick to bowl, slightly | more browning than | crumbled apart easily |
| | darker dough. When | the other, slight | in mouth, no off |
| | dough ball was torn, | speckling on the | flavor |
| | cell structure could be | lighter biscuit, a few | |
| | seen, tearing caused | layers could be seen, | |
| | apparent damage to | slight cracking, greyish | |
| | cells, slight elasticity | coloring after 24 hours. | |
| Bisquick + Sample B | Dry, formed a sticky | One biscuit | Crisp outside, mild |
| | dough ball when | experienced much | gummy texture, |
| | mixed, light dough | more browning than | crumbled apart |
| | color, When dough | the other, slight | |
| | ball was torn there | cracking, greyish | |
| | was no apparent | coloring after 24 hours. | |
| | damage to cell | | |
| | structure, had flaky | | |
| | appearance, no | | |
| | elasticity | | |
| Bisquick Comparison | The original Bisquick | The original Bisquick | The original Bisquick |
| | mixture was wet and | was very fluffy with | became gummy |
| | would not form | large air pockets like a | immediately upon |
| | whereas the Sample | bakery biscuit whereas | mastication whereas |
| | Biscuits formed | the Sample Biscuits | the sample biscuits |
| | dough balls. The | resembled a Pillsbury | crumbled and then |
| | Sample A₂ dough | canned biscuit. Sample | became gummy. The |
| | absorbed into the mix | A₂ biscuits had a | standard Sample |
| | much more and | slightly more | Biscuit was the least |
| | created a darker | consistent shape, | gummy. The original |
| | dough when | whereas the Sample B | Bisquick biscuit |
| | compared to Sample B. | biscuit appeared | appeared to have a |
| | | clumpier. | hard crust but could |
| | | | not be felt when |
| | | | chewed. |
| Gluten Free Bisquick | Very lumpy | Dark points on outside, | Crunchy outside, |
| | appearance, yellow | appeared fluffy, slight | gritty texture when |
| | color, appears very | cracking where surface | chewed, became |
| | dense | points were higher, | gummy after a few |
| | | very yellow inside, | cycles of mastication |
| | | biscuits resistant when | |
| | | torn apart | |
| Gluten Free Bisquick + | Uneven coloring, | Golden color, | Crumbled when in |
| Sample A₂ | moist but formed a | resembled a Pillsbury | mouth, then became |
| | ball, slightly stuck to | canned biscuit, lots of | slightly gummy, |
| | bowl, large cell | small cracks, small air | slight gritty feeling, |
| | structures when torn | pockets when torn, | no difference felt |
| | apart | consistent color | between crust and |
| | | throughout, broke, | inside of biscuit |
| | | biscuits broke when | |
| | | torn apart | |
| Gluten Free Bisquick + | Even coloring, | Light golden color, | Crumbled when in |
| Sample B | resembles a Pillsbury | resembles a Pillsbury | mouth, then became |
| | canned biscuit, stuck | canned biscuit, | moderately gummy, |
| | to bowl, medium cell | consistent color on | slightly gritty, no |
| | structures when torn | whole outside of | difference felt |
| | apart. | biscuit, a lot of small | between crust and |
| | | cracks, small air | inside of biscuit |
| | | pockets when torn, | |
| | | biscuits broke when | |
| | | torn apart | |
| Gluten Free Bisquick | The original Gluten | No resemblance | The original Gluten |
| comparison | Free Biscuit was very | between original | Free Biscuit had a |
| | lumpy and wet, fiber | Gluten Free Biscuit | definite crunch but no |
| | biscuits formed balls | and fiber biscuits. | snap when biting into |
| | upon mixing. | Sample Biscuits had | the crust, Sample |
| | | many small cracks and | Biscuits were had a |
| | | even more even | consistent crumbling |
| | | coloring when | texture throughout. |
| | | compared to original | Original recipe was |
| | | recipe. | very gritty compared |
| | | | to Sample Biscuits. |
| PURIS ™ Biscuit | Very wet, slight | Lumpy, uneven | No off flavor, |
| | yellow color, did not | coloring, very dark | crunchy outside, |
| | form a ball | points, crumbly, | gummy upon |
| | | moderate air pocket | mastication |
| | | structure, small cracks | |
| PURIS ™ Biscuit + | Forms a ball upon | Golden brown with | Very grainy texture, |
| Sample A₂ | mixing, very dark | dark and light points, | crumbled extremely |
| | dough | large cracks, medium | easy, becomes |
| | | air cells, very crumbly | gummy upon |
| | | upon breaking | mastication, no off |
| | | | flavor |
| PURIS ™ Biscuit + | Formed a ball upon | Dark golden brown, | Slightly grainy |
| Sample B | mixing, fairly dark | mainly dark points, | texture, moderately |
| | dough | appears very dense, | crumbly, becomes |
| | | almost no cell structure | gummy upon |
| | | | mastication, no off |
| | | | flavor |
| PURIS ™ Biscuit | Original PURIS ™ | Original PURIS ™ | Sample A biscuit was |
| Comparison | biscuit forms a thick | biscuit has the darkest | the most crumbly. |
| | paste upon mixing | points and appears | Equal gummy texture |
| | whereas the fiber | more cloud like rather | between all three |
| | biscuits form dough | than a standard biscuit | PURIS ™ biscuits. |
| | balls. The fiber | shape. PURIS ™ | |
| | doughs were much | Sample Biscuits were | |
| | darker, with the | the darkest biscuits | |
| | extruded fiber dough | throughout and were | |
| | being the darkest. | the most crumbly. | |

Bisquick Biscuits: The control biscuit had a moderately thin batter that is typical with drop biscuits. Once baked, the biscuits were light and fluffy with moderate browning. These biscuits resembled a dinner roll biscuit with very dark edges and a large light crack. Sample A₂ Bisquick dough was extremely dry and formed a ball rather than the thinner drop biscuit. The Sample B Bisquick Biscuit was also dry and formed a ball, but not as dry as the Sample A biscuit. The Sample A and Sample B biscuits resembled a Pillsbury canned biscuit in shape and general appearance.

Gluten Free Bisquick Biscuits: The control Bisquick batter resembled mashed potatoes with the finished biscuit being very yellow, light and fluffy. Biscuits were uneven with dark peaks. The Sample A₂ Gluten Free Bisquick was the darkest of the three Gluten Free Bisquick variations and expanded slightly more than the Sample B biscuit. As with the Bisquick biscuits, the Sample A₂ version was slightly drier than the Sample B version, with both forming dough balls. The Sample A₂ and Sample B biscuits resembled a Pillsbury canned biscuit in shape and general appearance. The Sample B Gluten Free Bisquick biscuit had faint browning in certain areas with deep cracks that would most likely resemble the control Bisquick if further baked.

PURIS™ Biscuits: The control PURIS™ biscuit closely resembled the Gluten Free Bisquick control biscuit, only with much more browning. As with the previous experiments, the Sample A₂ and Sample B biscuits resembled a Pillsbury canned biscuit in shape and general appearance. The Sample A₂ biscuit expanded more than the Sample B biscuit and had much deeper cracks. The PURIS™ biscuits with added fiber were extremely crumbly.

Experiment 2:

PURIS™ Biscuits: The PURIS™ biscuit recipes with an additional 2 Tbsp water showed similar characteristics to the control PURIS™ biscuit. These biscuits were all golden brown with slightly darker peaks, typical of drop biscuits. When tearing the biscuits apart they crumbled and broke rather than showing any elasticity. Small to medium size cracks could be seen with very few air pockets within the biscuits. The biscuits held together better and were less gummy than the PURIS™ biscuits+fiber with no added water. The PURIS™ biscuit recipes with an additional ¼ cup of water had no peaks and resembled pita bread more than a biscuit. The Sample B biscuits with ¼ cup of water displayed large air pockets and rose slightly. The Sample A biscuits with ¼ cup of water displayed very large air pockets and rose approximately an inch more than the Sample B fiber biscuits. Darker golden brown points were also seen in the Sample A biscuits when compared to the Sample B biscuits.

Bisquick Biscuits: The control Bisquick biscuits appeared to be light and fluffy with medium to large air pockets. The tops of the biscuits experienced varying degrees of browning. The fiber biscuits with no additional fiber closely resembled the results from Experiment 1 and were crumbly with very dark golden peaks. The fiber biscuits with the additional 2 Tbsp of water resembled the biscuits from Experiment 1. The Sample biscuits with additional water were less crumbly and gritty than those without the extra water. Sample A fiber Bisquick biscuits with an added quarter cup of water closely resembled the original Bisquick Biscuit. This biscuit was lightly golden brown, light and fluffy, with medium to large air pockets. They were very similar in bite and chew to the original Bisquick recipe. The Sample B fiber biscuit with an additional ¼ cup of water had batter consistent with pancake batter. After being baked, the biscuit resembled a pancake, thin and rubbery.

Gluten Free Bisquick Biscuits: The control gluten free biscuits were golden brown, light and fluffy in appearance. After masticating the biscuits became grainy. The grainy feeling increased with time along with the toughness of the biscuit. The inside of the biscuit and small to medium size air cells. When adding the Sample A and Sample B fiber with no added water, the biscuits became drier and more crumbly. The Sample A biscuits had a toasty flavor whereas the Sample B biscuits had a beany flavor. When adding the additional 2 Tbsp of water, the biscuits appeared to be the same and were even more difficult to masticate. Refrigerating and freezing increased the toughness of the biscuits for both Sample A and Sample B fiber. After adding the ¼ cup of water, both the Sample A and Sample B fiber biscuits resembled cloud bread. These biscuits were lightly domed shape with the Sample A biscuit being slightly more browned. Both biscuits were easy to masticate and were still slightly gritty. The toughness of the biscuits increased as the storage temperature decreased.

Conclusions: The effects of the Sample A and Sample B pea hull fiber can be clearly seen in this experiment. When adding fiber to an existing recipe with no additional water, the fiber absorbs excess moisture causing a much drier and denser end product. Sample A fiber absorbs slightly more than the Sample B fiber in all of the testing. The Sample A fiber produced more body within the product than the Sample B fiber. Adding an extra 2 Tbsp per 10 grams of fiber, increased binding is observed with the added water. To obtain a biscuit with the closest characteristics to the original recipe, adding ¼ cup of water per 10 grams of Sample A fiber. Sample A pea hull fiber results in more advanced Maillard browning and an increase in toasted flavor and pasting capabilities.

Results: Experiment 1

TABLE 12
Effect of time and temperature on biscuits in Biscuit Experiment 1.

| Experiment | 24 hrs, room temp | 24 hrs, 34° F. | 24 hrs, 0° F. |
|---|---|---|---|
| Gluten Free Bisquick* | Extremely hard, | Extremely hard, | Extremely hard, |
| | rough, and gritty, like | rough, and gritty, like | rough, and gritty, like |
| | sand | sand | sand |
| Gluten Free Bisquick + | Softer than Sample A | Softer than Sample A | Softer than Sample A |
| Sample B Fiber* | fiber biscuit but | fiber biscuit but | fiber biscuit but |
| | similar air cells | similar air cells | similar air cells |
| Gluten Free Bisquick + | Soft, slightly gritty | Harder than room | Harder than 34° C. still |
| Sample A Fiber* | | temperature, still | gritty |
| | | gritty | |
| PURIS ™ Biscuit | No off flavor, | crumblier | crumbliest |
| | crumbly | | |
| PURIS ™ Biscuit + | No off flavor, no | Beany, crumbly, more | Crumbly, beany |
| Sample B | beany flavor | neutral flavor | flavor |
| PURIS ™ Biscuit + | No off flavor, | Dusty, gritty, crumbly | Dusty, gritty, crumbly |
| Sample A | crumbly | | |

*Developed mold after 48 hours

TABLE 14
Biscuit Experiment 2 results, dough appearance, baked appearance, taste
and texture.

| Experiment | Dough Appearance | Baked Appearance | Taste & Texture |
|---|---|---|---|
| Bisquick | Wet, soupy | Fluffy, golden brown, | Soft, chewy |
| | | large air pockets | |
| Bisquick + Sample B | Very dry, forms | Hard looking, large | Chewy, only slightly |
| | dough ball | brown peaks, | gummy, crisp outside |
| Bisquick + Sample B + | Wet, thick mashed | Slightly more fluffy | Light, fluffy, chewy, |
| 2 Tbsp water | potato consistency, | than original recipe, | soft, similar to original |
| | similar to original | similar cell structure | recipe |
| | Bisquick but slightly | | |
| | thicker | | |
| Bisquick + Sample B + | Very runny | Didn't rise, brown | Chewy, resembles |
| ¼ c water | | edges | naan bread |
| Bisquick + Sample A | Very dry, had to add | Dark golden peaks, | Chewy, slightly beany, |
| | extra ⅛ c water | little air pockets, | crunchy outside |
| | | golden brown | |
| Bisquick + Sample A + | Wet, thick, more thick | Similar to Bisquick | Same as Bisquick |
| 2 Tbsp water | than native | but slightly chunkier | |
| Bisquick + Sample A + | Fluffy, thicker than | Light, fluffy, light | Soft, chewy, not |
| ¼ c water | Sample B version | golden, large air cells | gummy, no off flavor |
| Gluten Free Bisquick | Light and fluffy, | Crispy outside, | Crispy, fluffy inside, |
| | looked like boxed | golden brown points | didn't dissolve until |
| | mashed potatoes, | | thoroughly masticated |
| Gluten Free Bisquick + | Dry, slightly crumbly | Looked like a baking | Crunchy, good flavor, |
| Sample B | | powder biscuit, | didn't crumble to |
| | | varying degrees of | much |
| | | browning. | |
| Gluten Free Bisquick + | Similar to Gluten Free | Light colored, large | Soft inside, no beany |
| Sample B + 2 Tbsp | Bisquick but thicker | air pockets | flavor, chewy |
| water | | | |
| Gluten Free Bisquick + | Extremely wet, and | Sugar cookie | Slight beany flavor, |
| Sample B + ¼ c | fluffy | appearance, barely | soft, chewy |
| water | | browned, large air | |
| | | pockets | |
| Gluten Free Bisquick + | Dry, crumbly | Very dry, crumbly, | Dry, crunchy, a little |
| Sample A | | big cracks golden | gritty |
| | | brown | |
| Gluten Free Bisquick + | Wet, fluffy, holds | Golden brown, | Crunchy outside, soft |
| Sample A + 2 Tbsp | shape | medium air pockets, | inside, no beany flavor |
| water | | | |
| Gluten Free Bisquick + | Extremely wet, didn't | Golden brown peaks, | Chewy, fluffy, crisp |
| Sample A + 2 Tbsp | hold shape, whipped | light brown, large air | outside, no beany |
| water | appearance | pockets | flavor |
| PURIS ™ Biscuit + | Pancake batter | Large air cells, | Beany, crumbly, |
| Sample A + ¼ cup | consistency | slightly golden | dissolved but not pasty |
| water | | brown, extremely | |
| | | fluffy, medium cracks | |
| PURIS ™ Biscuit + | Drop biscuit dough | Small to medium air | Light, fluffy, a little |
| Sample A + 2 Tbsp | appearance, wet | cells, small cracks, | gritty, resembles |
| cup water | | light golden brown | focaccia bread |
| PURIS ™ Biscuit + | Pancake batter | Sugar cookie | Slightly gritty, didn't |
| Sample B + ¼ cup | consistency | appearance, small, | dissolve until |
| water | | medium, and large | masticated thoroughly |
| | | cell structure, | |
| | | crumbly | |
| PURIS ™ Biscuit + | Drop biscuit dough | Rough looking, | Slightly |
| Sample B + 2 Tbsp | appearance, wet | looked like a drop | metallic/beany, light |
| cup water | | biscuit, minimal | texture |
| | | browning, crumbled | |
| | | easily | |

TABLE 15
Biscuit: Experiment 2 results, effect of time and temperature on biscuits.

| | | | |
|---|---|---|---|
| Experiment | 24 hrs, room temp | 24 hrs, 34° F. | 24 hrs, 0° F. |
| Bisquick | Soft, tasted like | Soft, slightly tougher | Rubbery, hard to |
| | bread, masticated | than room | masticate |
| | easily, non-crumbly | temperature | |
| Bisquick + Sample B | Smeared in mouth, | More rubbery and | Pasted easily, rubbery |
| | more body than | tougher than room | |
| | Sample A fiber | temperature | |
| | version, less toasty | | |
| | flavor than Sample A | | |
| Bisquick + Sample B + | Soft to touch, when | Spreads easier, tasted | Spongy, tougher than |
| 2 Tbsp water | masticated it | like a cracker, larger | 34° F., dry |
| | resembles stale bread, | air cells, spongy | |
| | raw to taste, very soft | | |
| | bite, pasted like bread | | |
| Bisquick + Sample B + | Thin, like a tough | Tougher than room | Tougher than 34° F. |
| ¼ c water | pancake | temperature | |
| Bisquick + Sample A | Tougher first bite | Tough, a little | Toasty, not much |
| | than Sample B | rubberier than room | difference between 34° F. |
| | biscuit, pasted in | temperature, good | and 0° F. |
| | mouth | toasty flavor, not as | |
| | | pasty as room | |
| | | temperature, slight | |
| | | beany flavor, more | |
| | | browning than | |
| | | Sample B | |
| Bisquick + Sample A + | Toasty, dense, pasted | Soft, chewy, tasted | Much tougher, toasty |
| 2 Tbsp water | upon mastication, | like bread, more | flavor, harder to cut |
| | short texture, soft | biscuit like texture | than the Sample B |
| Bisquick + Sample A + | Nearly identical to | Slightly tougher then | Slightly tougher than |
| ¼ c water | original Bisquick | room temperature | 34° F. |
| | recipe, more toasted | | |
| | flavor than original | | |
| | Bisquick | | |
| Gluten Free Bisquick | Dry, hard to chew, no | Smooth initial, gritty | Chewy, rubbery, hard |
| | toasted flavor, grainy | after masticating, | to masticate, broke |
| | | didn't paste | apart, didn't paste |
| Gluten Free Bisquick + | Dense, dusty, gritty, | Expanded slightly, | Dry, very hard to chew |
| Sample B | didn't paste | fluffy, didn't paste, | |
| | | gritty | |
| Gluten Free Bisquick + | Toasted bread flavor, | Harder to masticate, | More rubbery, very dry, |
| Sample B + 2 Tbsp | more surface bite, | slightly gritty flavor | hard to masticate |
| water | darker | | |
| Gluten Free Bisquick + | Softer, beany notes | Didn't mush, no | More beany, slightly |
| Sample B + ¼ cup | | toasty notes, raw | toucher than room |
| water | | bread flavor | temperature |
| Gluten Free Bisquick + | Darker than Sample | More compact, | Difficult to cut, |
| Sample A | B biscuit, harder, | darkest, crumbly, | crumbly, similar to |
| | heavier cracking, | sourdough like taste, | 34° F. |
| | toasty notes, tasted | masticated to pasty, | |
| | like a cracker when | difficult to cut | |
| | masticated, pasted | | |
| | when thoroughly | | |
| | mixed with saliva | | |
| Gluten Free Bisquick + | More toasted flavor | Darker than Sample | Darker than Sample B, |
| Sample A + 2 Tbsp | than Sample B, more | B, harder to chew, | toasted notes, not as |
| water | surface bite, darker | toasty flavor | hard to chew |
| Gluten Free Bisquick + | Toasted bread, a little | Hard to chew, toasted | More resistant to first |
| Sample A + ¼ cup | pastier, similar air | flavor | bite, good toasted flavor |
| water | cells to original | | |
| | Gluten Free Bisquick | | |
| | recipe. | | |
| PURIS ™ Biscuit + | Soft, not beany, not | Not as beany, a little | More body, dissolves in |
| Sample A + ¼ cup | as gritty, better air | pastier | mouth better, tasted |
| water | cells | | toastier |
| PURIS ™ Biscuit + | Light, fluffy, fluffy, | Soft, fluffy, slight | Stuck to mouth, gritty |
| Sample A + 2 Tbsp | powdery upon | beany notes, pasted | |
| cup water | mastication, slightly | more than Sample B | |
| | beany | | |
| PURIS ™ Biscuit + | Soft but gritty | Beany, gritty, dusty, | Beany, grainy/powdery |
| Sample B + ¼ cup | | hard | |
| water | | | |
| PURIS ™ Biscuit + | Beany, gritty, dusty | powdery | Beany, |
| Sample B Pea Hull | | | bitter/sharp/metallic |
| Fiber + 2 Tbsp cup | | | taste |
| water | | | |

TABLE 15
Biscuit Experiment 1 Recipes

| | | Experiment Recipe (¼ recipe + |
|---|---|---|
| Experiment | Original Recipe | fiber) |
| Bisquick | 2¼ c Bisquick | ½ c Bisquick |
| | ⅔ c Milk | 3 Tbsp Milk |
| Bisquick + Sample A | 2¼ c Bisquick | ½ c Bisquick |
| | ⅔ c Milk | 3 Tbsp Milk |
| | | 10 g Sample A |
| Bisquick + Sample B | 2¼ c Bisquick | ½ c Bisquick |
| | ⅔ c Milk | 3 Tbsp Milk |
| | | 10 g Sample B |
| Gluten Free Bisquick | 2 c Gluten Free Bisquick | ½ c Gluten Free Bisquick |
| | ⅓ c Shortening | 1 Tbsp 1 tsp Shortening |
| | ⅔ c Milk | 3 Tbsp Milk |
| | 3 eggs | 1 egg |
| Gluten Free Bisquick + | 2 c Gluten Free Bisquick | ½ c Gluten Free Bisquick |
| Sample A | ⅓ c Shortening | 1 Tbsp 1 tsp Shortening |
| | ⅔ c Milk | 3 Tbsp Milk |
| | 3 eggs | 1 egg |
| | | 10 g Sample A |
| Gluten Free Bisquick + | 2 c Gluten Free Bisquick | ½ c Gluten Free Bisquick |
| Sample B | ⅓ c Shortening | 1 Tbsp 1 tsp Shortening |
| | ⅔ c Milk | 3 Tbsp Milk |
| | 3 eggs | 1 egg |
| | | 10 g Sample B |
| PURIS ™ Biscuit | 1 pkg PURIS ™ Gluten Free | 70 g PURIS ™ Gluten Free |
| | Waffle and Baking Mix | Waffle and Baking Mix |
| | 2 eggs | ½ egg |
| | ¼ c shortening | 2 Tbsp shortening |
| | ½ cup milk | 2 Tbsp milk |
| PURIS ™ Biscuit + Sample A | 1 pkg PURIS ™ Gluten Free | 70 g PURIS ™ Gluten Free |
| | Waffle and Baking Mix | Waffle and Baking Mix |
| | 2 eggs | ½ egg |
| | ¼ c shortening | 2 Tbsp shortening |
| | ½ cup milk | 2 Tbsp milk |
| | | 10 g Sample A |
| PURIS ™ Biscuit + Sample B | 1 pkg (242 g) PURIS ™ | 70 g PURIS ™ Gluten Free |
| | Gluten Free Waffle and | Waffle and Baking Mix |
| | Baking Mix | ½ egg |
| | 2 eggs | 2 Tbsp shortening |
| | ¼ c shortening | 2 Tbsp milk |
| | ½ cup milk | 10 g Sample B |

TABLE 16
Biscuit Experiment 2 recipe variations.

| | | Experiment Recipe (¼ recipe + |
|---|---|---|
| Experiment | Original Recipe | fiber) |
| Bisquick | 2¼ c Bisquick | ½ c Bisquick |
| | ⅔ c Milk | 3 Tbsp Milk |
| Bisquick + Sample A | 2¼ c Bisquick | ½ c Bisquick |
| | ⅔ c Milk | 3 Tbsp Milk |
| | | 10 g Sample A |
| Bisquick + Sample A + 2 Tbsp | 2¼ c Bisquick | ½ c Bisquick |
| Water | ⅔ c Milk | 3 Tbsp Milk |
| | | 10 g Sample A |
| | | 2 Tbsp Water |
| Bisquick + Sample A + ¼ cup | 2¼ c Bisquick | ½ c Bisquick |
| Water | ⅔ c Milk | 3 Tbsp Milk |
| | | 10 g Sample A |
| | | ¼ cup Water |
| Bisquick + Native Sample B | 2¼ c Bisquick | ½ c Bisquick |
| | ⅔ c Milk | 3 Tbsp Milk |
| | | 10 g Native Sample B |
| Bisquick + Native Sample B + | 2¼ c Bisquick | ½ c Bisquick |
| 2 Tbsp Water | ⅔ c Milk | 3 Tbsp Milk |
| | | 10 g Native Sample B |
| | | 2 Tbsp Water |
| Bisquick + Native Sample B + | 2¼ c Bisquick | ½ c Bisquick |
| ¼ cup Water | ⅔ c Milk | 3 Tbsp Milk |
| | | 10 g Native Sample B |
| | | ¼ cup Water |
| Gluten Free Bisquick | 2 c Gluten Free Bisquick | ½ c Gluten Free Bisquick |
| | ⅓ c Shortening | 1 Tbsp 1 tsp Shortening |
| | ⅔ c Milk | 3 Tbsp Milk |
| | 3 eggs | 1 egg |
| Gluten Free Bisquick + | 2 c Gluten Free Bisquick | ½ c Gluten Free Bisquick |
| Sample A | ⅓ c Shortening | 1 Tbsp 1 tsp Shortening |
| | ⅔ c Milk | 3 Tbsp Milk |
| | 3 eggs | 1 egg |
| | | 10 g Sample A |
| Gluten Free Bisquick + | 2 c Gluten Free Bisquick | ½ c Gluten Free Bisquick |
| Sample A + 2 Tbsp Water | ⅓ c Shortening | 1 Tbsp 1 tsp Shortening |
| | ⅔ c Milk | 3 Tbsp Milk |
| | 3 eggs | 1 egg |
| | | 10 g Sample A |
| | | 2 Tbsp Water |
| Gluten Free Bisquick + | 2 c Gluten Free Bisquick | ½ c Gluten Free Bisquick |
| Sample A + ¼ cup Water | ⅓ c Shortening | 1 Tbsp 1 tsp Shortening |
| | ⅔ c Milk | 3 Tbsp Milk |
| | 3 eggs | 1 egg |
| | | 10 g Sample A |
| | | ¼ cup Water |
| Gluten Free Bisquick + Native | 2 c Gluten Free Bisquick | ½ c Gluten Free Bisquick |
| Sample B | ⅓ c Shortening | 1 Tbsp 1 tsp Shortening |
| | ⅔ c Milk | 3 Tbsp Milk |
| | 3 eggs | 1 egg |
| | | 10 g Native Sample B |
| Gluten Free Bisquick + Native | 2 c Gluten Free Bisquick | ½ c Gluten Free Bisquick |
| Sample B + 2 Tbsp Water | ⅓ c Shortening | 1 Tbsp 1 tsp Shortening |
| | ⅔ c Milk | 3 Tbsp Milk |
| | 3 eggs | 1 egg |
| | | 10 g Native Sample B |
| | | 2 Tbsp Water |
| Gluten Free Bisquick + Native | 2 c Gluten Free Bisquick | ½ c Gluten Free Bisquick |
| Sample B + ¼ cup Water | ⅓ c Shortening | 1 Tbsp 1 tsp Shortening |
| | ⅔ c Milk | 3 Tbsp Milk |
| | 3 eggs | 1 egg |
| | | 10 g Native Sample B |
| | | ¼ cup Water |
| PURIS ™ Biscuit | 1 pkg PURIS ™ Gluten Free | 70 g PURIS ™ Gluten Free |
| | Waffle and Baking Mix | Waffle and Baking Mix |
| | 2 eggs | ½ egg |
| | ¼ c shortening | 2 Tbsp shortening |
| | ½ cup milk | 2 Tbsp milk |
| PURIS ™ Biscuit + Sample A | 1 pkg PURIS ™ Gluten Free | 70 g PURIS ™ Gluten Free |
| | Waffle and Baking Mix | Waffle and Baking Mix |
| | 2 eggs | ½ egg |
| | ¼ c shortening | 2 Tbsp shortening |
| | ½ cup milk | 2 Tbsp milk |
| | | 10 g Sample A |
| PURIS ™ Biscuit + Sample A + | 1 pkg PURIS ™ Gluten Free | 70 g PURIS ™ Gluten Free |
| 2 Tbsp Water | Waffle and Baking Mix | Waffle and Baking Mix |
| | 2 eggs | ½ egg |
| | ¼ c shortening | 2 Tbsp shortening |
| | ½ cup milk | 2 Tbsp milk |
| | | 10 g Sample A |
| | | 2 Tbsp Water |
| PURIS ™ Biscuit + Sample A + | 1 pkg PURIS ™ Gluten Free | 70 g PURIS ™ Gluten Free |
| ¼ cup Water | Waffle and Baking Mix | Waffle and Baking Mix |
| | 2 eggs | ½ egg |
| | ¼ c shortening | 2 Tbsp shortening |
| | ½ cup milk | 2 Tbsp milk |
| | | 10 g Sample A |
| | | ¼ cup Water |
| PURIS ™ Biscuit + Native | 1 pkg (242 g) PURIS ™ | 70 g PURIS ™ Gluten Free |
| Sample B | Gluten Free Waffle and | Waffle and Baking Mix |
| | Baking Mix | ½ egg |
| | 2 eggs | 2 Tbsp shortening |
| | ¼ c shortening | 2 Tbsp milk |
| | ½ cup milk | 10 g Native Sample B |
| PURIS ™ Biscuit + Native | 1 pkg (242 g) PURIS ™ | 70 g PURIS ™ Gluten Free |
| Sample B + 2 Tbsp Water | Gluten Free Waffle and | Waffle and Baking Mix |
| | Baking Mix | ½ egg |
| | 2 eggs | 2 Tbsp shortening |
| | ¼ c shortening | 2 Tbsp milk |
| | ½ cup milk | 10 g Native Sample B |
| | | 2 Tbsp Water |
| PURIS ™ Biscuit + Native | 1 pkg (242 g) PURIS ™ | 70 g PURIS ™ Gluten Free |
| Sample B + ¼ cup Water | Gluten Free Waffle and | Waffle and Baking Mix |
| | Baking Mix | ½ egg |
| | 2 eggs | 2 Tbsp shortening |
| | ¼ c shortening | 2 Tbsp milk |
| | ½ cup milk | 10 g Native Sample B |
| | | 2 Tbsp Water |

Table 14 includes evaluation results of biscuit Samples (A: Untreated Fiber; B: Treated Fiber; No Added Fiber) produced with 10 g added fiber content or no added fiber content, different biscuit base formulas (a, b, c,), and different water addition amounts (zero, 2 Tbs, and ¼ cup additional water). Biscuits made with each biscuit base and each added water amount were stored at different temperatures (room temperature, refrigerated temperature, and frozen temperature) over different storage times (0 hrs, 48 hrs, 84 hrs).

Table 14 includes biscuits with base a (Bisquick (General Mills, MN)) containing the following recipe and preparation directions (Sample with no additional water addition: Sample with 2 TBS additional water addition; Sample with ¼ cup additional water addition)

Table 14 includes biscuits with base b (Gluten Free Bisquick (General Mills, MN)) containing the following recipe and preparation directions: (Sample with no additional water addition: Sample with 2 TBS additional water addition; Sample with ¼ cup additional water addition)

Table 14 includes biscuits with base c (Experimental) containing the following formula and preparation directions: (Sample with no additional water addition: Sample with 2 TBS additional water addition; Sample with ¼ cup additional water addition)

Conclusions from Biscuit Examples: The effects of the extruded and native pea hull fiber can be clearly seen in this experiment. When adding fiber to an existing recipe with no additional water, the fiber absorbs excess moisture causing a much drier and denser end product. Extruded fiber absorbs slightly more than the native fiber in all of the testing. The extruded fiber produced more body within the product than the native fiber. Adding an extra 2 Tbsp per 10 grams of fiber, increased binding is observed with the added water. To obtain a biscuit with the closest characteristics to the original recipe, add ¼ cup of water per 10 grams of extruded fiber. Extruded pea hull fiber results in more advanced Maillard browning and an increase in toasted flavor and pasting capabilities.

Butter Cookie Examples

Objective: Determine functionality of pea hull fiber in gluten free butter cookies.

TABLE 17
Sample Codes and Descriptions

| Sample | Code | Ingredient |
|---|---|---|
| Control | 104 | PS870CPX |
| 1 | 827 | PS870CPX + Sample B |
| 2 | 955 | PS870CPX + Sample A₂ |
| 3 | 363 | PS870CPX + Sample A₂ + Sample B |

Method: Butter mixed on speed 6 in KitchenAid 5-Quart Bowl Lift Mixer (Model: K5SSWH) using a New Metro Design Original Beater Blade (Model: KA-5L) for 2 minutes. Added sugar and beat on speed 6 for 2 minutes. Scraped down sides of the bowl. Added egg and vanilla and beat on speed 6 for 2 minutes. Scraped down sides of the bowl. Added flour and fiber, mix until soft dough forms. Placed dough on plastic wrap and roll into a log. Placed dough in refrigerator (35° F.) overnight. Removed dough from refrigerator and let sit at ambient temperature (75° F.) for 10 minutes. Sliced dough into ¼ inch pieces and place 1 inch apart on a parchment lined baking sheet. Baked at 350° F. for 15 minutes. Removed cookies on parchment from pan onto a wire rack to cool completely.

Sample dough made on Aug. 16, 2017. Samples baked and evaluated by panelists on Aug. 17, 2017.

Conclusions: PURIS™ ingredients can be utilized in the formulation of a light and crisp butter cookie. Minimal difference in appearance between each Sample. Unbaked Samples with added Sample B were slightly drier in texture than control and Sample A₂. Fiber added acted as a bulking agent to improve Sample texture as well as reduce loss during baking. Samples with added fiber retained more texture over shelf life testing than Control.

Gluten Free Cheese Cracker Examples

Objective: Develop and optimize a gluten free cheese cracker formula utilizing Samples A, A₂ and B.

TABLE 18
Cheese cracker formulas with added fiber formulation

| Ingredient | % |
|---|---|
| Sharp Cheddar Cheese | 22.00% |
| Cheddar Cheese | 22.00% |
| Butter | 12.05% |
| Salt | 1.17% |
| Flour | 24.49% |
| Fiber | 6.80% |
| Water | 11.50% |
| TOTAL | 100.00% |

TABLE 19
Sample Code and Descriptions

| Experiment | Ingredients | |
|---|---|---|
| 1 | PS870CPX + Sample B | Block cheese, shredded |
| | PS870CPX + Sample A₂ | |
| 2 | PS870CPX + Sample B | Pre-shredded cheese |
| | PS870CPX + Sample A₂ | |
| 3 | PS870CPX + Sample B | Block cheese, shredded |
| | PS870CPX + Sample A | |

Cracker Method: Combine butter, cheese and salt in a KitchenAid 5-Quart Bowl Lift Mixer (Model: K5SSWH) and blended using a New Metro Design Original Beater Blade (Model: KA-5L) for 2 minutes on speed 4. Add flour and fiber to bowl and blend on speed 2 for 30 seconds. Add water and blend until soft dough forms on speed 4 for 1 minute. Roll dough to 3/32 inch thickness on parchment, place in cooler (35° F.) for at least one hour. Cut dough into 1 inch squares and poke a hole in the center of each cracker. Bake 375° F. for 17 minutes, remove and place on wire rack to cool completely.

TABLE 20
Cracker Experiment 1 Observations: Samples baked Aug. 21, 2017

| | |
|---|---|
| Sample B | Crisp, light yellow color, good crunch, cheesy flavor, easy to |
| | roll out |
| | Day 2: kept texture, crunch and snap, good cheese flavor |
| | Day 3: Tough, little flavor, chewy, no snap |
| | Day 4: crisp crunch, good cheese flavor, stale, disintegrates |
| | quickly |
| Sample A₂ | Crisp, slightly gritty, uneven surface appearance, did not rise |
| | as much as Sample B, light cheesy flavor, harder snap |
| | Day 2: Good crunch, slightly gritty |
| | Day 3: Crunchy, good texture at beginning of chew, slightly |
| | gritty, not as cheesy |
| | Day 4: crunchy, good snap, off flavor, gritty finish |

TABLE 21
Experiment 2 Observations: Samples baked Aug. 21, 2017 (Day 1),
Samples observed on Aug. 22, 2017 (Day 2), Aug. 31, 2017 (Day 3)
and Sep. 6, 2017 (Day 4).

| | |
|---|---|
| Sample B | Day 1: Dark color, good browning, crunchy, dry, slightly |
| | burnt flavor, uneven surface, light cheddar flavor, slight gritty |
| | finish |
| | Day 2: louder snap and fist crunch, not as expanded as |
| | Sample B in Experiment 3 |
| | Day 3: Gritty, soft but crunchy on first bite, too browned |
| | Day 4: Crunchy, light, good cheddar flavor, slight metallic |
| | after taste |
| Sample A₂ | Day 1: Dark color, uneven color, metallic, |
| | bitter aftertaste, dry, gritty, |
| | Day 2: Metallic, bitter, slightly softer |
| | Day 3: Crunchy, faintly cheesy flavor, gritty |
| | Day 4: Crunchy, bitter, hard gritty as cracker disintegrates, |
| | dark browned notes |

TABLE 22
Experiment 3 observations: Samples baked Sep. 13, 2017 (Day 1) and
observed on Sep. 14, 2017 (Day 2)

| | |
|---|---|
| Sample B | Day 1: Crisp, light yellow color, good crunch, cheesy flavor, |
| | easy to roll out but dough slightly dry and crumbled |
| | Day 2: less bite during initial snap and chewing than |
| | Sample A |
| Sample A | Day 1: Crisp, good crunch, light cheesy flavor, easy to roll |
| | out - very pliable |
| | Day 2: Sample A slightly more browned caramelized notes |
| | but not as salty as Sample B. Sample A slightly more yellow |
| | than Sample B. |

Cracker Experiment Conclusions: Samples made during Experiment 1 are less browned than Samples made in Experiment 2 due to the processing aids in pre-shredded cheese. Sample A₂ made in Experiment 1 is crunchier and less gritty than Sample B after baking. As Samples age, Sample B becomes stale and has less crunch faster than Sample A. In Experiment 2; Sample B had a louder snap than Sample A₂, processing aids in pre shredded cheese caused Samples to be darker and have a bitter metallic after taste than Samples produced in Experiments 1 and Experiments 3. Both Samples made during Experiment 2 were crunchy but gritty during day 4 evaluation. Samples made during Experiment 3 were very similar to Experiment 1. Experiment 3, Sample A dough was softer, not as dry or crumbly and more pliable than Sample B. Experiment 3 Samples both crunchy and with similar flavor and color. Sample B does not change flavor or texture of the cracker but extends shelf life of product longer than crackers made with Sample B.

Drink Mix Example

Purpose: Determine differences between Sample A and Sample B when suspended in a protein drink mix.

Method: Protein drink mix is combined with fiber and added to a blender bottle with 285 grams cold water. Samples shook for 30 seconds then tasted and photographed at intervals to determine difference in separation.

TABLE 23
Sample Code and Descriptions for Drink Mix Experiment

| Experiment | Code | Sample |
|---|---|---|
| Experiment 1 | Control | Base Formula |
| | Sample B | Base Formula + Sample B |
| | Sample A | Base Formula + Sample A |
| Experiment 2 | Control | Base Formula |
| | Sample B | Base Formula + Sample B |
| | Sample A | Base Formula + Sample A |

TABLE 24
Base Protein Drink Mix Formula for Drink Mix Experiment

| Ingredient | % |
|---|---|
| Pea Protein | 85.14% |
| Sugar | 11.49% |
| Stevia | 0.26% |
| Monk Fruit Juice Extract | 0.17% |
| Guar Gum | 0.72% |
| Salt | 1.02% |
| Sweet Cream Flavor | 0.77% |
| Natural Vanilla Flavor WONF | 0.43% |

TABLE 25
Experiment 1 formula for Drink Mix Experiment

| Ingredient | % |
|---|---|
| Base Protein Drink Mix | 80.75% |
| Fiber | 19.25% |

TABLE 26
Experiment 2 formula for Drink Mix Experiment

| Ingredient | % |
|---|---|
| Base Protein Drink Mix | 67.71% |
| Fiber | 32.29% |

Drink Mix Experiment 1 Observations: Control Sample had a neutral vanilla flavor and a slightly gritty mouthfeel. Sample B had a more beany, dusty flavor than the control and was very smooth with a slight increase in body. Sample A had the most different flavor compared to the Control and Sample B. Sample A had more body and less gritty texture than control and Sample B but some small particles and grittiness was observed at the back of the throat. Control left undisturbed for 2 hours separated dramatically, leaving the largest amount of water. Sample B separated half as much as the Control Sample and Sample A separated one quarter.

Drink Mix Experiment 2 Observations: Sample B had a very beany flavor however the mouthfeel was smoother and had more body than the control. Sample A had a gritty mouthfeel and was much thicker than the Control Sample. Sample A did not have any off flavors. Similar separation of Samples observed as in Experiment 1.

Drink Mix Example Conclusions: Sample A improves the perceived texture of the product and maintains suspension. Samples A and B can be used to increase nutritional content of protein drink mixes without negatively impacting the product mouthfeel. Sample A imparts less beany flavor than Sample B. The addition of Sample B will slow product separation and Sample A will further slow separation.

Mousse Example

Purpose: To determine the effects of Sample A and Sample B on Mousse.

Method: A bulk batch (Control) of Mousse was made utilizing the formula in Table 27. Sample A and Sample B fibers were added separately to the bulk batch of Mousse as shown in Table 27. After preparation, they were analyzed immediately, after 12 hours of refrigeration and after a freeze thaw cycle.

TABLE 27
Mousse Experiment variations.

| | |
|---|---|
| Control Mousse | 16 oz Cool Whip |
| | 8 oz Egg White |
| | 2 cups Dark Chocolate Morsels |
| | 2 Tbsp Sugar |
| Sample A Mousse | 15 grams Sample A |
| | 150 g Control Mousse |
| Sample B Mousse | 15 grams Sample B |
| | 150 g Control Mousse |

Results:

TABLE 28
Mousse Experiment Results

| | Initial | 12 hr Refrigeration | Freeze Thaw |
|---|---|---|---|
| Control Mousse | Smooth, fluffy, | Light, Fluffy | Wet, Syneresis, Light, |
| | slightly gritty, | | Soft, |
| | Resembles Betty | | |
| | Crocker Mousse | | |
| Sample A Mousse | Smooth, Fluffy, | Fluffy, Slight off | No Syneresis, Light, |
| | Fluffy, Gritty, More | Flavor, Fluffy, Light, | Fluffy, More Body |
| | Body Than Control | More Body than | than Control |
| | | Control | |
| Sample B Mousse | Thick, Smooth, | Thick, Darker, | Smooth, Dense, “A |
| | Darker, Resembles a | Resembles Chocolate | Heavy Mousse” |
| | Ganache | Ice Cream | |

As seen in Table 28, not to be limited by theory, Sample A and Sample B fibers add several benefits to Mousse.

Conclusion: Sample A allows the mousse to stay light and fluffy, like the mousse typically thought of in America. The added fiber also allows for water control which eliminated syneresis in the freeze thaw cycle. Sample B created a much denser mousse that resembled chocolate ice cream. This mousse is closer to the European style mousse's that are much thicker. This fiber also eliminated the syneresis in the freeze thaw cycle. The superior fiber is a matter of personal mousse style, light and fluffy or dense. The results in this experiment suggest that the fiber would also be beneficial in ice cream and frozen yogurt.

The compositions and methods of the present invention are capable of being incorporated in the form of a variety of embodiments, only a few of which have been illustrated and described. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

What is claimed is:

1. A pea fiber product comprising:
a) at least 45% dry weight % fiber;
b) at least 5% dry weight % of the fiber is soluble fiber, and
c) not more than 15% dry weight % protein.

2. The pea fiber product of claim 1, wherein the pea fiber product has a same day viscosity of 300-1100 cp at 15 wt. % concentration and of 2150-2950 cp at 17 wt. % according to viscosity Test A run at 30 RPM.

3. The pea fiber product of claim 1, wherein the pea fiber product has a 60 hour viscosity of 1420-2220 cp at 15 wt. % concentration and of 6400-7200 cp at 17 wt. % concentration according to Test A run at 30 RPM.

4. The pea fiber product of claim 1, wherein the pea fiber product has at least 70 dwt. % fiber.

5. The pea fiber product of claim 1, wherein the pea fiber product has at least 90 dwt. % fiber.

6. The pea fiber product of claim 1, wherein the pea fiber product has not more than 10 dwt. % protein.

7. The pea fiber product of claim 1, wherein the pea fiber product has not more than 5 dwt. % protein.

8. The pea fiber product of claim 1, wherein the pea fiber product is in the format of expanded pieces, aerated pieces, pressed pieces, powder, or combinations thereof.

9. The pea fiber product of claim 8, wherein the pea fiber product further comprises ingredients selected from the group consisting of bulking agents, flavoring agents, coloring agents, sensients, dairy based ingredients, lentil based ingredients, soybean based ingredients, cereal based ingredients, food grade acids, food grade basic ingredients, food grade buffer ingredients, oils, fats, emulsifiers, and combinations thereof.

10. The process of making the pea fiber product of claim 1, comprising the steps: a) separating pea fiber from pea seeds to make an pea fiber intermediate material; b) mixing the pea fiber intermediate material with water to make a wetted fiber intermediate material; c) feeding the wetted fiber intermediate material into the inlet opening of a heating apparatus; d) applying heat, pressure, and shear to the wetted fiber intermediate material; e) conveying the wetted material to an exit port opposite the inlet opening of the heating apparatus; f) forcing the wetted intermediate material to exit the heating apparatus through a die in the exit port; g) causing the wetted intermediate material to expand upon exiting the exit port creating the pea fiber product.

11. The process of claim 10, wherein the pea fiber product is ground into a powder.

12. A process of making a pea fiber product of claim 1, comprising the steps of:
a. mixing and optionally preconditioning finely ground pea fiber intermediate materials with additional water, so that the preconditioned pea fiber intermediate material has no more than 40 wt. % water content;
b. adding the preconditioned ground fiber intermediate material to a first zone of the heating apparatus through an inlet port at one end of the apparatus;
c. mixing and conveying the fiber intermediate material to a heating zone at a screw rotational speed of about 300 to about 800 revolutions per minute;
d. mixing and heating the fiber intermediate material to no greater than 200° C. in this heating zone;
e. conveying the heated ground fiber intermediate material to a second heating and transferring zone;
f. mixing and heating the ground fiber intermediate material in the transfer zone;
g. conveying the heated ground fiber intermediate fiber from the transfer zone and out of the heating apparatus through the exit port and die at a temperature between about 80° C. and about 200° C. and a pressure of about 150 and about 350 PSI;
h. expanding the heated fiber intermediate material as it exits the die into ambient temperature and atmosphere environment;
i. cutting the expanded ground fiber intermediate material into pieces; and
j. cooling the cut expanded material into pieces of pea fiber product.

13. The process of claim 12, wherein the heating apparatus is run at a feed rate of not less than 50 lb/hour, preferably not less than 100 lb/hour, most preferably not less than 250 lb/hour.

14. The process of claim 12, wherein the pea fiber product is heated upon leaving the exit port to dry the pea fiber product to not more than 20 wt. % water, preferably to not more than 10 wt. % water, most preferably to not more than 5 wt. % water.

15. The process of claim 12, wherein the pea fiber product is cut into pieces by a knife after the exit port of the heating apparatus.

16. The process of making a pea fiber product of claim 1, comprising the steps of: a) separating pea fiber from pea seeds to make a pea fiber intermediate material; b) mixing the pea fiber intermediate material with water to make a wetted fiber intermediate material; c) feeding the wetted fiber intermediate material into the inlet opening of a heating apparatus; d) applying heat and pressure to the wetted fiber intermediate material; e) conveying wetted material to an exit port opposite the inlet opening of the heating apparatus; f) forcing the wetted intermediate material to exit through the exit port; g) causing the wetted intermediate material to expand upon exiting the exit port creating the pea fiber product.

17. The process of claim 16 wherein the process further includes cutting the expanded fiber material into expanded pieces as the expanded intermediate material exits the heating apparatus.

18. The process of claim 16 wherein the process further includes grinding the expanded pieces of pea fiber product into powder.

19. A beverage food product comprising the pea fiber product claim 1.

20. The beverage food product of claim 19, wherein the pea fiber product content is greater than 1, 5, 10, 12, 15, 20, 25, 30, or 40 wt. %.

21. A sauce food product comprising the pea fiber product of claim 1.

22. The sauce food product of claim 21, wherein the pea fiber product content is greater than 1, 5, 10, 12, 15, 20, 25, 30, or 40 wt. %.

23. The sauce food product of claim 21 is selected from the group consisting of gravies, white sauces, savory sauces, sweet sauces, cooking sauces, tomato based sauces, marinades, dressings and combinations thereof.

24. A bakery food product comprising the pea fiber product of claim 1.

25. The bakery food product of claim 24, wherein the pea fiber product content is greater than 1, 5, 10, 12, 15, 20, 25, 30, 40, 50, 60, 70, 80, 90, or 95 wt. %.

26. The bakery food product of claim 24 is selected from the group consisting of cookies, crackers, cakes, muffins, waffles, pancakes, ice cream cones, tortillas, chips, snack crackers, pretzels, extruded or puffed snacks, bread (chemically and yeast leavened) and combinations thereof.

27. An aerated dessert or confectionary food product comprising the pea fiber product of claim 1.

28. The aerated dessert or confectionary food product of claim 27, wherein the pea fiber product content is greater than 1, 5, 10, 12, 15, 20, 25, 30, or 40 wt. %.

29. The aerated dessert or confectionary food product of claim 27 is selected from the group consisting of mousse, ice cream, frozen yogurt, frappe, meringue, nougat, icing, whipped topping, and whipped cream products, and combinations thereof.

30. A meat analog food product comprising the pea fiber product of claim 1.

31. The meat analog food product of claim 30, wherein the pea fiber product content is greater than 1, 5, 10, 12, 15, 20, 25, 30, 40, or 60 wt. %.

32. The meat analog food product of claim 30 is selected from the group consisting of vegetable and/or lentil based mixtures, patties, loaves, pieces or combinations thereof used as substitutes for ground or chunked meat.
